(19) United States
(12) Patent Application Publication
(10) Pub. No.: US 2005/0259884 A1
(43) Pub. Date: Nov. 24, 2005

(54) Image processing apparatus, image forming apparatus, image processing method, program, and recording medium

(75) Inventors: Yoshinori Murakami, Yamatokoriyama-shi (JP); Hitoshi Hirohata, Kashihara-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/130,179

(22) Filed: May 17, 2005

(30) Foreign Application Priority Data
May 18, 2004 (JP) P2004-148141
Feb. 3, 2005 (JP) P2005-028176

(51) Int. Cl. G06K 9/36

(52) U.S. Cl. 382/252

(57) ABSTRACT

A quantization error calculation portion calculates the difference between the pixel value of a pixel of an input image added with an accumulative error by the adder and the quantization value obtained by quantizing the pixel value in the quantization processing portion as a quantization error. The quantization error is stored in the error storage portion. The multiplier multiplies, a quantization error to be distributed to a subsequently-quantized pixel, among the quantization errors stored in the error storage portion, by the diffusion coefficient numerator value corresponding to the quantization error. The adder adds the multiplication result produced by the multiplier. The divider divides the addition result produced by the adder by the diffusion coefficient denominator value. The division result is outputted to the adder as an accumulative error for a subsequently-quantized pixel.

### BACKGROUND OF THE INVENTION

1. Field of the Invention

The present invention relates to an image processing apparatus, an image forming apparatus, an image processing method, a program, and a recording medium, for performing halftoning on input image data by means of error diffusion processing.

2. Description of the Related Art

In recent years, with rapid advancement of digitalization in OA (Office Automation) equipment, and also with a growing increase in demand for production of color image output, an image forming apparatus, such as that which allows color image output, has been coming into wider and wider use, for instance an electrophotographic digital color copier and an ink jet-type or thermal transfer-type color printer. For example, image information inputted from input equipment such as a digital camera or a scanner, or computer-generated image information can be outputted by the use of such image forming apparatuses. These image forming apparatuses are usually so designed that pseudo gradation reproduction processing is performed on input image data.

FIG. 15 is a block diagram showing an error diffusion processing circuit 70 employed in an image processing apparatus included in a first related-art image forming apparatus. As one of techniques for reproducing pseudo gradation, a so-called error diffusion method has been known. The error diffusion method can be implemented with use of the error diffusion processing circuit 70. The error diffusion processing circuit 70 is composed of an adder 71, a quantization processing portion 72, a quantization threshold value storage portion 73, a quantization error calculation portion 74, a diffusion error calculation portion 75, a diffusion coefficient storage portion 76, and an accumulative error storage portion 77.

In the adder 71, a pixel value representing the pixel density level of input image data and an accumulative error distributed from a pixel having been quantized precedent to a pixel of interest to the pixel of interest are added to each other. The accumulative error is read out from the accumulative error storage portion 77. In the quantization processing portion 72, the pixel value added with the accumulative error and a quantization threshold value stored in the quantization threshold value storage portion 73 are compared with each other, so that quantization may be performed to generate a quantization value for a pixel constituting output image data.

The quantization error calculation portion 74 which is a subtracter calculating the difference between the quantization value generated in the quantization processing portion 72 and the pixel value added with the accumulative error in the adder 71 as a quantization error. The diffusion coefficient storage portion 76 stores therein diffusion coefficients indicative of the proportion of the quantization error to be distributed to an unprocessed pixel of input image data. The diffusion error calculation portion 75 generates a diffusion error to be distributed to an unprocessed pixel of input image data by multiplying the quantization error generated by calculation in the quantization error calculation portion 74 by each of the diffusion coefficients stored in the diffusion coefficient storage portion 76. The diffusion error generated by calculation in the diffusion error calculation portion 75 is stored in the accumulative error storage portion 77 as an accumulative error.

FIG. 16 is a block diagram showing the error diffusion processing circuit 70A employed in the image processing apparatus included in a second related-art image forming apparatus. The error diffusion processing circuit 70A illustrated in the block diagram of FIG. 16 is designed to perform integer arithmetic operations. The error diffusion processing circuit 70A has basically the same structure as the error diffusion processing circuit 70 shown in FIG. 15, the difference being the configurations of the diffusion error calculation portion 75, the diffusion coefficient storage portion 76, and the accumulative error storage portion 77. Another difference is that an adder 78 is disposed therein.

The diffusion coefficient storage portion 76 is composed of a diffusion coefficient numerator storage portion 76a for storing values for the numerator of a diffusion coefficient represented by a fraction, and a diffusion coefficient denominator storage portion 76b for storing a value for the denominator of a diffusion coefficient represented by a fraction. Note that the denominator is common to all of the diffusion coefficients in use. The diffusion error calculation portion 75 is composed of a multiplier 75a and a divider 75b. The multiplier 75a generates the product of the quantization error generated by calculation in the quantization error calculation portion 74 and the value of each numerator component of a diffusion coefficient stored in the diffusion coefficient numerator storage portion 76a. The divider 75b generates a diffusion error to be distributed to an unprocessed pixel of input image data by dividing the multiplication result produced by the multiplier 75a by the value of the denominator component of a diffusion coefficient stored in the diffusion coefficient denominator storage portion 76b.

In the adder 78, the diffusion error generated by calculation in the divider 75b is added to the accumulative error in the corresponding pixel stored in the accumulative error storage portion 77. The addition result is stored in the accumulative error storage portion 77 as an updated accumulative error. There has been devised a modified version of the error diffusion processing circuit 70A that enables parallelization and speeding-up of the processing operations by preparing as many multipliers 75a, dividers 75b, and adders 78 as the number of pixels to which a single quantization error is distributed as a diffusion error.

FIGS. 17A through 17D are views of assistance in explaining diffusion coefficients for use in the error diffusion processing. FIG. 17A is a view for explaining general diffusion coefficients for use in the error diffusion processing circuit 70 shown in FIG. 15. Referring to FIG. 17A, a single rectangular region corresponds to a single pixel, and one region marked with asterisk (*) corresponds to a pixel that has already been quantized. The other four regions correspond to unprocessed pixels, namely, yet-to-be quantized pixels. The numerals (fractions) assigned to these four regions represent diffusion coefficients used to distribute the quantization error in the quantized pixel to the individual unquantized pixels.

In this example, four diffusion coefficients are provided: “7/16”; “1/16”; “5/16”; and “3/16”. For example, with respect to the pixel corresponding to “7/16”, a value obtained by multiplying the quantization error in the quantized pixel by the diffusion coefficient of “7/16” is taken as a diffusion error therefor.

FIG. 17B shows diffusion coefficients for use in a processing circuit of the type that performs integer arithmetic operations, namely, the error diffusion processing circuit 70A shown in FIG. 16. In FIG. 17B, while the correlation among pixels is the same as that shown in FIG. 17A, unprocessed pixels, namely, yet-to-be quantized pixels, are each expressed by the value of the numerator of a diffusion coefficient represented by a fraction, the denominator of which is common to all of the diffusion coefficients in use. In this example, four values for the numerator component of a diffusion coefficient: “7”; “1”; “5”; and “3” are shown separately from the value of the denominator “16”. In the error diffusion processing circuit 70A shown in FIG. 16, the numerator values are stored in the diffusion coefficient numerator storage portion 76a, whereas the denominator value is stored in the diffusion coefficient denominator storage portion 76b.

FIGS. 17C and 17D are views of assistance in explaining a diffusion error to be distributed from a quantized pixel to a yet-to-be quantized pixel. FIG. 17C shows diffusion coefficients for use in the error diffusion processing circuit 70 shown in FIG. 15. One region marked with asterisk (*) corresponds to a pixel to be quantized, and the other four regions correspond to pixels that have already been quantized. Each numeral (fraction) indicates a diffusion coefficient used to distribute the diffusion error to the pixel to be quantized.

In this example, four diffusion coefficients are provided: “7/16”; “1/16”; “5/16”; and “3/16”. For example, with respect to the pixel corresponding to “7/16”, a value obtained by multiplying the quantization error in the pixel by the diffusion coefficient of “7/16” is taken as a diffusion error to be distributed to the pixel marked with asterisk (*). Similarly, from the other three pixels, their respective diffusion errors are distributed to the pixel marked with asterisk (*). Eventually, the pixel marked with asterisk (*) is given the sum total of the diffusion error values.

FIG. 17D shows diffusion coefficients for use in a processing circuit of the type that performs integer arithmetic operations, namely, the error diffusion processing circuit 70A shown in FIG. 16. In this example, four values for the numerator component of a diffusion coefficient: “7”; “1”; “5”; and “3” are shown along with the value of the denominator “16”. In terms of the pixel marked with asterisk (*), the diffusion errors illustrated in FIGS. 17C and 17D can be considered as accumulative coefficients used to determine errors to be accumulated in the pixel.

In a processing circuit of the type that performs integer arithmetic operations, e.g. the error diffusion processing circuit 70A shown in FIG. 16, when a numerical value with a fractional part is obtained as a result of a division operation, all digits to the right of the decimal point are discarded or rounded off. Thus, the original quantization error does not necessarily conform to the sum total of the diffusion errors resulting from diffusion of the original quantization error.

Specifically, the diffusion error calculation portion 75 calculates an accumulative error to be added to an unprocessed pixel of input image data. Assuming that the quantization error is E(n) and the diffusion coefficient is Kij, then the accumulative error D is given by the following equation (1):
D=ε(Kij×E(n)) (1)

Provided that the diffusion coefficient Kij takes on four values as shown in FIG. 17A, then the accumulative error D can be determined by calculation using the equation (2) as will be shown hereinbelow. That is, the quantization error (E(1) to E(4)) in the quantized pixel and the diffusion coefficient are multiplied with each other. By adding up the multiplication results, the accumulative error D can be obtained.

$$D = E ( 1 ) \times \frac{1}{16} + E ( 2 ) \times \frac{5}{16} + E ( 3 ) \times \frac{3}{16} + E ( 4 ) \times \frac{7}{16} \qquad ( 2 )$$

At this time, for example, in a case where a numerical value obtained by calculation using the equation “E(1)×1÷16” has the number of decimal places, all digits to the right of the decimal point are discarded or rounded off. After that, the numerical value is added to the diffusion error values obtained by calculation on the basis of the other quantization errors E(2) through E(4) respectively. As a consequence, the number of decimal places having been discarded or rounded off is excluded from the accumulative error D. This means that part of the quantization error remains undiffused. In a low-density or high-density region in particular, there is a possibility that the quantization error is hardly diffused.

As one example of related art practices for making the quantization error attendant upon the above-described error diffusion processing coincide with the sum total of diffusion errors resulting from diffusion of the quantization error to unprocessed pixels, an image signal processing apparatus has been proposed to date (refer to Japanese Examined Patent Publication JP-B2 7-9672, for instance). In this construction, at the outset, a residual error is determined by calculating a difference between a multi-value error (quantization error) and the sum total of error distribution values (diffusion errors) resulting from distribution of the multi-value error to neighboring unprocessed pixels. Subsequently, the residual error is added to one of the error distribution values, and the addition result is then added to the accumulative error on the corresponding pixel position, together with the other error distribution values, whereby the existing accumulative error is updated. In this way, the multi-value error can be diffused wholly.

Moreover, an image signal processing apparatus of another type has been proposed to date (refer to Japanese Examined Patent Publication JP-B2 7-22334, for instance). In this construction, at the outset, a residual error is determined by calculating a difference between a binarization error (quantization error) and the sum total of error distribution values resulting from distribution of the binarization error to neighboring unprocessed pixels. Subsequently, the residual error is added to one of the error distribution values, and the addition result is then added to the accumulative error on the corresponding pixel position, together with the other error distribution values, whereby the existing accumulative error is updated. In this way, the binarization error can be diffused wholly.

However, the error diffusion processing methods exemplified by the above-explained prior art practices pose the following problems. After all, a residual error is determined by calculating a difference between a quantization error and the sum total of diffusion errors resulting from diffusion of the quantization error, and the residual error is added to one of the diffusion error values. In order to perform this addition operation, an extra circuit is required, which leads to an undesirable increase in the size of circuitry. The larger the circuitry size, the slower the processing operation.

### SUMMARY OF THE INVENTION

An object of the invention is to provide an image processing apparatus, an image forming apparatus, an image processing method, a program, and a recording medium that enable minimization of errors caused by discarding fractional parts in integer arithmetic operations, without increasing the size of circuitry and without decreasing processing speed.

The invention provides an image processing apparatus comprising:
first addition means for adding, an accumulative error distributed to a pixel to be quantized to a pixel value of the pixel to be quantized, among accumulative errors resulting from distribution of a quantization error attendant upon quantization of a pixel value representing a pixel density of an input image to other pixels;
quantization processing means for generating a quantization value for a pixel constituting an output image by quantizing the pixel value added with the accumulative error by the first addition means;
quantization error calculation means for calculating a difference between the pixel value added with the accumulative error by the first addition means and the quantization value generated in the quantization processing means as a quantization error;
multiplication means for multiplying the quantization error generated by calculation in the quantization error calculation means by a value of each of numerators of a diffusion coefficient represented by a fraction indicating a proportion of the quantization error to be distributed to other pixels;
second addition means for adding, a multiplication result corresponding to a pixel to be quantized next, among multiplication results produced by the multiplication means; and
division means for dividing an addition result produced by the second addition means by a value of a denominator the diffusion coefficient represented by the fraction,
wherein a division result produced by the division means is taken as an accumulative error which is distributed to a pixel to be quantized next.

In the invention, it is preferable that the image processing apparatus further comprises error storage means for storing therein the quantization error generated by calculation in the quantization error calculation means,
wherein the multiplication means serves to multiply, among the quantization errors stored in the error storage means, a quantization error to be distributed to a pixel to be quantized next, by the value of the numerator of the diffusion coefficient that corresponds to the quantization error to be distributed, and
wherein the second addition means serves to add computation results produced by the multiplication means.

The invention provides an image processing apparatus comprising:
first addition means for adding, with respect to an input image composed of plural lines each including plural pixels, an accumulative error distributed to a pixel to be quantized to a pixel value of the pixel to be quantized, among accumulative errors resulting from distribution of a quantization error attendant upon quantization of a pixel value representing a pixel density of the input image to other pixels;
quantization processing means for generating a quantization value for a pixel constituting an output image by quantizing the pixel value added with the accumulative error by the first addition means;
quantization error calculation means for calculating a difference between the pixel value added with the accumulative error by the first addition means and the quantization value generated in the quantization processing means as a quantization error;
multiplication means for multiplying the quantization error generated by calculation in the quantization error calculation means by a value of each of numerators of a diffusion coefficient represented by the fraction indicating a proportion of the quantization error to be distributed to other pixels;
line accumulative error calculation means including:
second addition means for adding, with respect to plural error diffusion lines including pixels to which a quantization error in a pixel included in a quantization line including pixels to be quantized is distributed, a multiplication result produced by the multiplication means on the basis of the quantization error in the pixel included in the quantization line, on a pixel-by-pixel basis, and
division means for dividing an addition result produced by the second addition means by a value of a denominator of the diffusion coefficient represented by the fraction,
the line accumulative error calculation means calculating a division result produced by the division means as a line accumulative error, the line accumulative error calculation means being provided for each of the error diffusion lines; and
third addition means for adding, with respect to a pixel to be quantized next, line accumulative errors generated by calculation in the line accumulative error calculation means corresponding to the individual error diffusion lines,
wherein an addition result produced by the third addition means is taken as an accumulative error which is distributed to the pixel to be quantized next.

In the invention, it is preferable that the image processing apparatus, wherein the line accumulative error calculation means for the last error diffusion line including a pixel to be quantized last includes first line error storage means for storing therein a division result produced by the division means, and calculates the division result stored in the first line error storage means as a line accumulative error,
wherein another line accumulative error calculation means for each of the error diffusion lines other than the last error diffusion line and the first error diffusion line including a pixel to be quantized first includes fourth addition means for adding a division result produced by the division means to a line accumulative error generated with respect to a pixel corresponding to the division result by calculation in yet another accumulative error calculation means corresponding to the error diffusion line subsequent to the error diffusion line of interest, and second line error storage means for storing therein an addition result produced by the fourth addition means, and calculates the addition result stored in the second line error storage means as a line accumulative error, and
wherein the third addition means serves to add up, instead of line accumulative errors generated by calculation by the accumulative error calculation means, line accumulative errors generated by calculation by other line accumulative error calculation means for the first error diffusion line and the next line accumulative error calculation means for the error diffusion line subsequent to the first error diffusion line.

The invention provides an image forming apparatus comprising:
the image processing apparatus mentioned above; and
an image output device for producing an output image that has been undergone a quantization process in the image processing apparatus.

The invention provides an image processing method comprising:
a first addition step of adding, an accumulative errors distributed to a pixel to be quantized to a pixel value of the pixel to be quantized, among accumulative errors resulting from distribution of a quantization error attendant upon quantization of a pixel value representing a pixel density of an input image to other pixels;
a quantization step of generating a quantization value for a pixel constituting an output image by quantizing the pixel value added with the accumulative error in the first addition step;
a quantization error calculation step of calculating a difference between the pixel value added with the accumulative error in the first addition step and the quantization value generated in the quantization step as a quantization error;
a multiplication step of multiplying the quantization error generated by calculation in the quantization error calculation step by a value of each of numerators of a diffusion coefficient represented by a fraction indicating a proportion of the quantization error to be distributed to other pixels;
a second addition step of adding, a multiplication result corresponding to a pixel to be quantized next among multiplication results produced in the multiplication step; and
a division step of dividing an addition result produced in the second addition step by a value of a denominator of the diffusion coefficient represented by the fraction,
wherein a division result produced in the division step is taken as an accumulative error which is distributed to the pixel to be quantized next.

The invention provides an image processing method comprising:
a first addition step of adding, with respect to an input image composed of plural lines each including plural pixels, an accumulative error distributed to a pixel to be quantized to a pixel value of the pixel to be quantized, among accumulative errors resulting from distribution of a quantization error attendant upon quantization of a pixel value representing a pixel density of the input image to other pixels;
a quantization step of generating a quantization value for a pixel constituting an output image by quantizing the pixel value added with the accumulative error in the first addition step;
a quantization error calculation step of calculating a difference between the pixel value added with the accumulative error in the first addition step and the quantization value generated in the quantization step as a quantization error;
a multiplication step of multiplying the quantization error generated by calculation in the quantization error calculation step by a value of each of numerators of a diffusion coefficient represented by a fraction indicating a proportion of the quantization error to be distributed to other pixels;
a second addition step of adding, with respect to plural error diffusion lines including pixels to which a quantization error in a pixel included in a quantization line including pixels to be quantized is distributed, a multiplication result produced in the multiplication step on the basis of the quantization error in the pixel included in the quantization line, on a pixel-by-pixel basis;
a division step of dividing an addition result produced in the second addition step by a value of a denominator of the diffusion coefficient represented by the fraction;
a line accumulative error calculation step of calculating a division result produced in the division step as a line accumulative error, error-diffusion line by error-diffusion line; and
a third addition step of adding, with respect to a pixel to be quantized next, line accumulative errors generated by calculation error-diffusion line by error-diffusion line in the line accumulative error calculation step,
wherein an addition result produced in the third addition step is taken as an accumulative error which is distributed to the pixel to be quantized next.

In the invention, it is preferable that, in the line accumulative error calculation step, with respect to each of the error diffusion lines other than the first error diffusion line including a pixel to be quantized first and the last error diffusion line including a pixel to be quantized last, a division result produced in the division step and, a line accumulative error generated for a pixel corresponding to the division result, among line accumulative errors generated for the error diffusion line subsequent to the error diffusion line of interest corresponding to the division result, are added to each other, for generating a line accumulative error, and
wherein in the third addition step, instead of the line accumulative errors generated for the individual error diffusion lines, line accumulative errors corresponding to the first error diffusion line and the error diffusion line subsequent to the first error diffusion line are added together.

The invention provides a program for causing a computer to function as the image processing apparatus.

The invention provides a computer-readable recording medium for recording therein the program.

According to the invention, at the outset, through the first addition means, among the accumulative errors resulting from distribution of a quantization error attendant upon quantization of a pixel value representing the pixel density of an input image to the other pixels, the accumulative error distributed to a pixel to be quantized is added to the pixel value of the pixel to be quantized. Secondly, through the quantization processing means, a quantization value for a pixel constituting an output image is generated by quantizing the pixel value added with the accumulative error by the first addition means. Thirdly, through the quantization error calculation means, the difference between the pixel value added with the accumulative error by the first addition means and the quantization value generated in the quantization processing means is calculated as a quantization error.

Fourthly, through the multiplication means, the quantization error generated by calculation in the quantization error calculation means is multiplied by the value for each of the numerators of a diffusion coefficient represented by a fraction indicating the proportion of the quantization error to be distributed to the other pixels. Fifthly, through the second addition means, among the multiplication results produced by the multiplication means, the multiplication results corresponding to a pixel to be quantized next are added together. Last of all, through the division means, the addition result produced by the second addition means is divided by the value for the denominator of the diffusion coefficient represented by the fraction. Eventually, the division result produced by the division means is taken as an accumulative error which is distributed to a pixel to be quantized next.

By performing a division operation last of all in that way, it is possible to minimize errors caused by discarding fractional parts in integer arithmetic operations without increasing the size of circuitry by disposing an extra circuit for performing error correction. This makes it possible to output image data in which the tone reproducibility of the low-density and high-density regions is improved remarkably. Moreover, as compared with the case of adding a circuit for performing error correction, processing operations can be achieved at higher speed.

In order to realize computation result storage means for storing therein the product of the quantization error and the numerator component of the diffusion coefficient, it is necessary to prepare a buffer having a capacity large enough to hold the sum of the bit lengths according to the quantization error and a specific coefficient. However, in the invention, instead of the computation result storage means, the error storage means is provided that stores therein the quantization error. This makes it possible to achieve operations with use of a buffer having enough capacity for only the bit length according to the quantization error. Another advantage is that errors caused by discarding fractional parts in integer arithmetic operations can be minimized successfully without increasing the size of circuitry and without decreasing processing speed.

Moreover, according to the invention, at the outset, through the first addition means, with respect to an input image composed of plural lines each including plural pixels, among the accumulative errors resulting from distribution of a quantization error attendant upon quantization of a pixel value representing the pixel density of the input image to the other pixels, the accumulative error distributed to a pixel to be quantized and the pixel value of the pixel to be quantized are added to each other. Secondly, through the quantization processing means, a quantization value for a pixel constituting an output image is generated by quantizing the pixel value added with the accumulative error by the first addition means. Thirdly, through the quantization error calculation means, the difference between the pixel value added with the accumulative error by the first addition means and the quantization value generated in the quantization processing means is calculated as a quantization error.

Fourthly, through the multiplication means included in the line accumulative error calculation means, the quantization error generated by calculation in the quantization error calculation means is multiplied by the value for each of the numerators of a diffusion coefficient represented by a fraction indicating the proportion of the quantization error to be distributed to the other pixels. Fifthly, through the second addition means included in the line accumulative error calculation means, with respect to plural error diffusion lines including pixels to which a quantization error in a pixel included in a quantization line including pixels to be quantized is distributed, the multiplication results produced by the multiplication means on the basis of the quantization error in the pixel included in the quantization line are added together pixel by pixel. Sixthly, through the division means included in the line accumulative error calculation means, the addition result produced by the second addition means is divided by the value for the denominator of the diffusion coefficient represented by the fraction. Seventhly, through the line accumulative error calculation means provided for each of the error diffusion lines, the division result produced by the division means is calculated as a line accumulative error.

Last of all, through the third addition means, with respect to a pixel to be quantized next, all of the line accumulative errors generated by calculation in the line accumulative error calculation means corresponding to the individual error diffusion lines are added together. The addition result produced by the third addition means is taken as an accumulative error which is distributed to the pixel to be quantized next.

As described above, in order to derive the accumulative error on the basis of the quantization error, the diffusion coefficient is divided into a numerator component and a denominator component, and the sum of the products of the quantization error and each numerator component of the diffusion coefficient obtained for each of the error diffusion lines is divided pixel by pixel. In this way, it is possible to suppress accumulation of division errors that arise every time a single quantization error is diffused to neighboring pixels, and thereby output image data in which the tone reproducibility of the low-density and high-density regions is improved. Moreover, by reducing the bit numbers of the line accumulative error and the multiplication result and the number of the multiplication results to be stored, it is possible to reduce the storage capacity of the memory for holding computation results.

According to the invention, through the line accumulative error calculation means, the line accumulative error generated by the other line accumulative error calculation means corresponding to the next error diffusion line and the division result produced by the division means with respect to the pixel corresponding to the line accumulative error are added to each other. It is thus essential only that the line error storage portion corresponding to the third error diffusion line be given enough capacity for as many line accumulative errors as the number of pixels belonging to a single line. Thus, in contrast to the case where the division result and the line accumulative error corresponding to the next error diffusion line are not added to each other, the larger the number of error diffusion lines to which the quantization error is distributed, the smaller the memory capacity of the line error storage portion can be.

Moreover, according to the invention, by performing a division operation last of all, it is possible to minimize errors caused by discarding fractional parts in integer arithmetic operations without increasing the size of circuitry by disposing an extra circuit for performing error correction. This makes it possible to form an image in which the tone reproducibility of the low-density and high-density regions is improved remarkably. Moreover, as compared with the case of adding a circuit for performing error correction, processing operations can be achieved at higher speed.

Further, according to the invention, at the outset, in the first addition step, among the accumulative errors resulting from distribution of a quantization error attendant upon quantization of a pixel value representing the pixel density of an input image to the other pixels, the accumulative error corresponding to a pixel to be quantized is added to the pixel value of the pixel to be quantized. Secondly, in the quantization step, a quantization value for a pixel constituting an output image is generated by quantizing the pixel value added with the accumulative error in the first addition step. Thirdly, in the quantization error calculation step, the difference between the pixel value added with the accumulative error in the first addition step and the quantization value generated in the quantization step is calculated as a quantization error.

Fourthly, in the multiplication step, the quantization error generated by calculation in the quantization error calculation step is multiplied by the value for each of the numerators of a diffusion coefficient represented by a fraction indicating the proportion of the quantization error to be distributed to the other pixels. Fifthly, in the second addition step, among the multiplication results produced in the multiplication step, the multiplication results corresponding to a pixel to be quantized next are added together. Last of all, in the division step, the addition result produced in the second addition step is divided by the value for the denominator of the diffusion coefficient represented by the fraction. The division result produced in the division step is taken as an accumulative error which is distributed to a pixel to be quantized next.

By performing a division operation last of all in that way, it is possible to minimize errors caused by discarding fractional parts in integer arithmetic operations without performing error correction. This makes it possible to produce image data in which the tone reproducibility of the low-density and high-density regions is improved remarkably. Moreover, as compared with the case of performing error correction, processing operations can be achieved at higher speed.

According to the invention, at the outset, in the first addition step, with respect to an input image composed of plural lines each including plural pixels, among the accumulative errors resulting from distribution of a quantization error attendant upon quantization of a pixel value representing the pixel density of the input image to the other pixels, the accumulative error distributed to a pixel to be quantized and the pixel value of the pixel to be quantized are added to each other. Secondly, in the quantization step, a quantization value for a pixel constituting an output image is generated by quantizing the pixel value added with the accumulative error in the first addition step. Thirdly, in the quantization error calculation step, the difference between the pixel value added with the accumulative error in the first addition step and the quantization value generated in the quantization step is calculated as a quantization error.

Fourthly, in the multiplication step, the quantization error generated by calculation in the quantization error calculation step is multiplied by the value for each of the numerators of a diffusion coefficient represented by a fraction indicating the proportion of the quantization error to be distributed to the other pixels. Fifthly, in the second addition step, with respect to plural error diffusion lines including pixels to which a quantization error in a pixel included in a quantization line including pixels to be quantized is distributed, the multiplication results produced in the multiplication step on the basis of the quantization error in the pixel included in the quantization line are added together pixel by pixel. Sixthly, in the division step, the addition result produced in the second addition step is divided by the value for the denominator of the diffusion coefficient represented by the fraction. Seventhly, in the line accumulative error calculation step, the division result produced in the division means is calculated as a line accumulative error, error-diffusion line by error-diffusion line.

Last of all, in the third addition step, with respect to a pixel to be quantized next, all of the line accumulative errors corresponding to the individual error diffusion lines generated by calculation in the line accumulative error calculation step are added together. The addition result produced in the third addition step is taken as an accumulative error which is distributed to the pixel to be quantized next.

As described above, in order to derive the accumulative error on the basis of the quantization error, the diffusion coefficient is divided into a numerator component and a denominator component, and the sum of the products of the quantization error and each numerator component of the diffusion coefficient obtained for each of the error diffusion lines is divided pixel by pixel. In this way, it is possible to suppress accumulation of division errors that arise every time a single quantization error is diffused to neighboring pixels, and thereby output image data in which the tone reproducibility of the low-density and high-density regions is improved.

According to the invention, in the line accumulative error calculation step, the line accumulative error corresponding to the next error diffusion line and the division result produced in the division step with respect to the pixel corresponding to the line accumulative error are added to each other. It is thus essential only that the memory for holding the line accumulative error corresponding to the third error diffusion line be given enough capacity for as many line accumulative errors as the number of pixels belonging to a single line. Thus, in contrast to the case where the division result and the line accumulative error corresponding to the next error diffusion line are not added to each other, the larger the number of error diffusion lines to which the quantization error is apportioned, the smaller the memory capacity of the line error storage portion can be.

Moreover, according to the invention, the image processing apparatus can be realized by effecting each of the means constituting the image processing apparatus under the control of a computer.

Further, according to the invention, the image processing apparatus can be realized on a computer by means of an image processing program read out from a recording medium.

### BRIEF DESCRIPTION OF THE DRAWINGS

Other and further objects, features, and advantages of the invention will be more explicit from the following detailed description taken with reference to the drawings wherein:

FIG. 1 is a block diagram showing the schematic configuration of a color image processing apparatus according to one embodiment of the invention and a color image forming apparatus including the color image processing apparatus;

FIG. 2 is a block diagram showing a tone reproduction processing section of a first example included in the color image processing apparatus according to the embodiment of the invention;

FIG. 3 is a block diagram showing a tone reproduction processing section of a second example included in the image processing apparatus according to another embodiment of the invention;

FIG. 4 is a flow chart for explaining a method of image processing according to still another embodiment of the invention;

FIG. 5 is a view showing the configuration of a printer driver and a computer including the printer driver according to yet another embodiment of the invention;

FIG. 6 is a block diagram showing a tone reproduction processing section of a third example included in the image processing apparatus according to yet another embodiment of the invention;

FIG. 7 is a view of assistance in explaining diffusion coefficients stored in the diffusion coefficient storage portion shown in FIG. 6;

FIG. 8 is a flow chart for explaining a method of image processing effected by the tone reproduction processing section shown in FIG. 6;

FIG. 9 is a block diagram showing a tone reproduction processing section of a forth example included in the image processing apparatus according to yet another embodiment of the invention;

FIG. 10 is a view of assistance in explaining diffusion coefficients stored in the diffusion coefficient storage portion shown in FIG. 9;

FIG. 11 is a block diagram showing a tone reproduction processing section of a fifth example included in the image processing apparatus according to yet another embodiment of the invention;

FIGS. 12A through 12E are views of assistance in explaining the storage capacity of the line error storage portion shown in FIGS. 9 and 11;

FIG. 13 is a flow chart for explaining a method of image processing effected by the tone reproduction processing section shown in FIG. 11;

FIG. 14 is a block diagram showing a tone reproduction processing section of a sixth example included in the image processing apparatus according to yet another embodiment of the invention;

FIG. 15 is a block diagram showing an error diffusion processing circuit employed in an image processing apparatus included in a first related-art image forming apparatus;

FIG. 16 is a block diagram showing an error diffusion processing circuit employed in the image processing apparatus included in a second related-art image forming apparatus; and

FIGS. 17A through 17D are views of assistance in explaining diffusion coefficients for use in the error diffusion processing.

### DETAILED DESCRIPTION

Now referring to the drawings, preferred embodiments of the invention are described below.

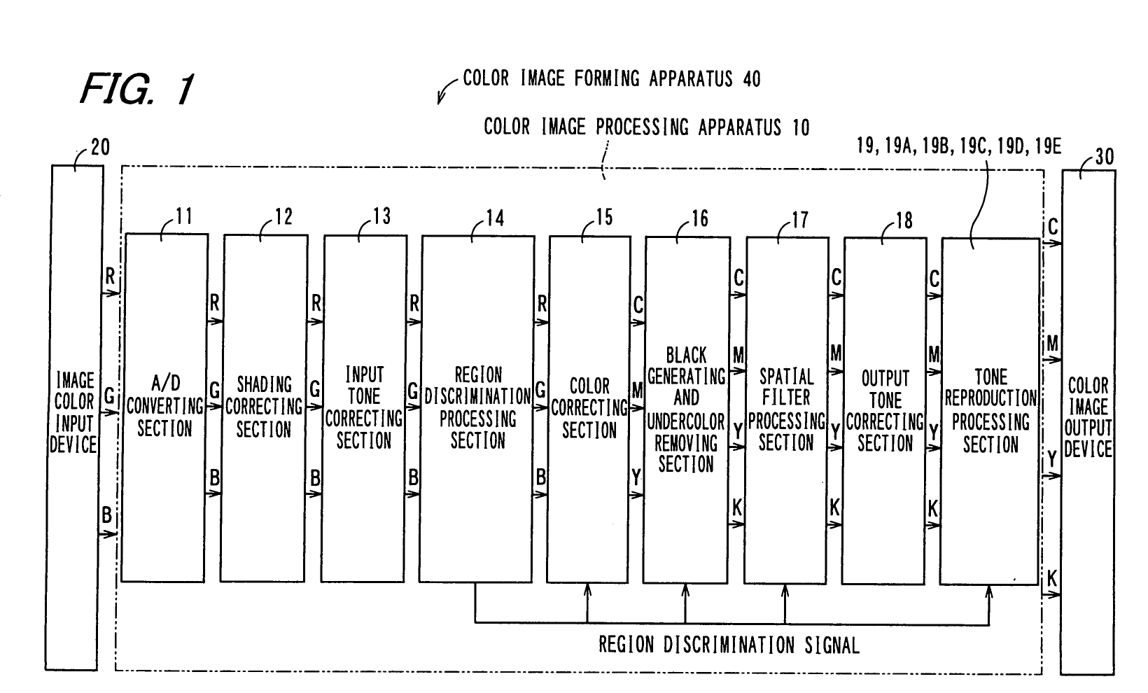

FIG. 1 is a block diagram showing the schematic configuration of a color image processing apparatus 10 according to one embodiment of the invention and a color image forming apparatus 40 including the color image processing apparatus 10. The color image forming apparatus 40, which is built as an apparatus for forming images such as a digital color copier, is composed of a color image processing apparatus 10 acting as an image processing apparatus, a color image input device 20, a color image output device 30, and a non-illustrated operation panel.

For example, the operation panel includes a touch panel constructed by combining a display portion such as a liquid crystal display and an operating portion such as a setting button with each other. On the basis of the information inputted from the operation panel, the workings of the color image processing apparatus 10, the color image input device 20, and the color image output device 30 are controlled.

For example, the color image input device 20 includes a scanner portion provided with a CCD (Charge Coupled Device) image sensor. In the color image input device 20, the CCD image sensor receives light reflected from a paper sheet on which an image or the like is recorded. The reflected light is converted into RGB (Red-Green-Blue) analog signals and are then inputted to the color image processing apparatus 10. In this cases the data of images taken by a digital camera or the like can also be used as input data.

The color image processing apparatus 10 is composed of an A/D (analog-to-digital) converting section 11, a shading correcting section 12, an input tone correcting section 13, a region discrimination processing section 14, a color correcting section 15, a black generating and undercolor removing section 16, a spatial filter processing section 17, an output tone correcting section 18, and a tone reproduction processing section 19.

The RGB analog signals obtained through a conversion process effected by the color image input device 20 are processed by the A/D converting section 11, the shading correcting section 12, the input tone correcting section 13, the region discrimination processing section 14, the color correcting section 15, the black generating and undercolor removing section 16, the spatial filter processing section 17, the output tone correcting section 18, and the tone reproduction processing section 19, each of which is arranged within the color image processing apparatus 10, successively in the order named, whereby CMYK (Cyan-Magenta-Yellow-Black) digital color signals are outputted to the color image output device 30 for producing image data output on a recording medium such as a paper sheet, for instance, an electrophotographic digital color copier or an ink jet-type or thermal transfer-type color printer.

The A/D converting section 11 of the color image processing apparatus 10 converts input RGB analog signals into digital signals. The RGB digital signals fed from the A/D converting section 11 are then processed by the shading correcting section 12 to remove off various distortions caused in the illuminating system, the imaging system, or the image-taking system of the color image input device 20.

The input tone correcting section 13 adjusts the color balance of the RGB signals, now freed from various distortions by the shading correcting section 12, namely, RGB reflection factor signals, and simultaneously converts the signal into such a signal as is suitable for use in the image processing system employed in the color image processing apparatus 10, for instance, a density signal.

The region discrimination processing section 14 classifies the individual pixels constituting an input image under a plurality of regions including a character region, a halftone dot region, and a photographic region on the basis of the RGB signals fed from the input tone correcting section 13. In accordance with the discrimination result, the region discrimination processing section 14 outputs a region discrimination signal indicating the belonging of each pixel to the color correcting section 15, the black generating and undercolor removing section 16, the spatial filter processing section 17, and the tone reproduction processing section 19, respectively, and simultaneously outputs the RGB signals fed from the input tone correcting section 13 directly to the color correcting section 15 placed downstream thereof.

In order to achieve a faithful reproduction of original colors, the color correcting section 15 performs color correction processing by eliminating color impurity including unnecessarily absorbed components according to the spectral characteristics of a CMY (Cyan-Magenta-Yellow) coloring material. The processing is achieved by means of LUT (Look Up Table) for holding the correspondence between RGB signals inputted and CMY signals outputted, or by means of color masking using such a conversion matrix as will be shown below as the equation (3).

$$( \begin{matrix}C \\ M \\ Y\end{matrix} ) = ( \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ) ( \begin{matrix}R \\ G \\ B\end{matrix} ) \qquad ( 3 )$$

For example, in the case of adopting the color masking method, a multiplicity of combinations of RGB data and CMY data fed to the color image output device 30 are prepared for use. The RGB data is obtained by reading out, with use of a scanner, a color patch having an L*a*b* value (according to L*a*b*signals defined by CIE (Commission International de l' Eclairage) (1976); L* represents a luminosity factor and a* and b* represent chromaticity) identical with the L*a*b* value for a color outputted upon specific CMY signals being fed to the color image output device 30. On the basis of the data combinations, color correction coefficients ranging from a₁₁ to a₃₃ in the conversion matrix of the equation (3) are generated by calculation. Then, color correction processing is performed with use of the coefficients thus generated. By using a conversion matrix containing high degree terms (second-order or above), it is possible to attain higher accuracy in the color correction processing.

In the black generating and undercolor removing section 16, black generation processing is performed for deriving a K (black) signal from three-color CMY signals obtained after color correction effected by the color correcting section 15. Moreover, new CMY signals are generated by subtracting superposition in the original CMY signals, whereby three-color CMY signals are converted into four-color CMYK signals.

In the spatial filter processing section 17, the image data represented by the CMYK signals fed from the black generating and undercolor removing section 16 is subjected to spatial filter processing, by means of a digital filter, on the basis of the region discrimination signal fed from the region discrimination processing section 14. By correcting the spatial frequency characteristics of the signals, it is possible to avoid a fuzziness and granular quality degradation in an output image.

The output tone correcting section 18 performs output tone correction processing for converting a signal such as a density signal into a halftone-dot area percentage, which corresponds to a characteristic value of the color image output device 30.

In the tone reproduction processing section 19, just as is the case with the spatial filter processing section 17, the image data represented by the CMYK signals is subjected to specific processing on the basis of the region discrimination signal fed from the region discrimination processing section 14, so that the tone of the image may be falsely reproduced eventually.

For example, with respect to the region discriminated as the character region by the region discrimination processing section 14, in order to enhance the reproducibility of a black character or color character in particular, a high-frequency component is accentuated through a sharpness enhancement process in spatial filter processing effected by the spatial filter processing section 17. At the same time, in the tone reproduction processing section 19, a choice is made between binarization processing and multi-value processing, and the region is binarized or multi-valued using a high-resolution screen suitable for reproduction of the high-frequency component. Moreover, the region discriminated as the halftone dot region by the region discrimination processing section 14 is subjected to low-pass filter processing in the spatial filter processing section 17 to remove an input halftone-dot component. The region is then binarized or multi-valued using a screen in which particular importance is placed on the tone property in the tone reproduction processing section 19. Further, the region discriminated as the photographic region by the region discrimination processing section 14 is binarized or multi-valued using a screen in which particular importance is placed on the tone reproducibility in the tone reproduction processing section 19.

The image data having been processed in the tone reproduction processing section 19 is stored once in a non-illustrated memory disposed within the color image processing apparatus 10. Afterwards, the image data is read out and inputted to the color image output device 30 at a predetermined timing.

Note that the color image processing apparatus 10 is provided with a non-illustrated CPU (Central Processing Unit) for performing the above-stated processing operations.

The invention is characterized by the configuration of the tone reproduction processing section 19 of the color image processing apparatus included in the color image forming apparatus 40 according to one embodiment of the invention. The tone reproduction processing section 19 serves not only to perform error diffusion processing solely on the pixels belonging to the halftone dot region, but also to perform error diffusion processing on each and every pixel regardless of the region. More details of the tone reproduction processing section 19 will be explained later on.

Basically, image data is constituted by the density values for the individual CMYK colors. Since the error diffusion processing is common to all of the colors, the following description deals only with the error diffusion processing on the density value for a single, specific color. Although no explanation will be given, the error diffusion processing applies also to the other colors.

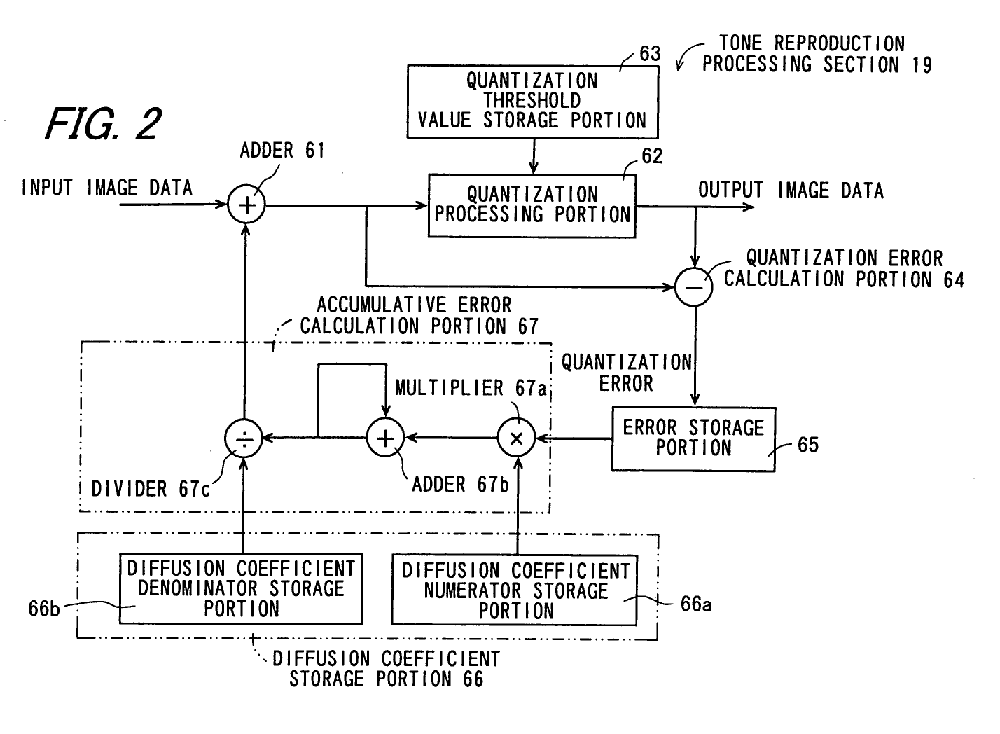

FIG. 2 is a block diagram showing the tone reproduction processing section 19 of a first example included in the color image processing apparatus 10 according to one embodiment of the invention. The tone reproduction processing section 19 is composed of an adder 61, a quantization processing portion 62, a quantization threshold value storage portion 63, a quantization error calculation portion 64, an error storage portion 65, a diffusion coefficient storage portion 66, and an accumulative error calculation portion 67.

In the adder 61 serving as first addition means, an accumulative error generated by calculation in the accumulative error calculation portion 67 is added to a pixel value representing the pixel density of input image data. In the quantization processing portion 62 serving as quantization processing means, the pixel value added with the accumulative error by the adder 61 is quantized in accordance with a quantization threshold value stored in the quantization threshold value storage portion 63, whereby a quantization value for a pixel constituting output image data is obtained. The quantization error calculation portion 64 serving as a subtracter is quantization error calculation means, and calculates the difference between the pixel value added with the accumulative error by the adder 61 and the quantization value obtained by quantizing the pixel value in the quantization processing portion 62 as a quantization error. The resultant quantization error is stored in the error storage portion 65 serving as error storage means.

The diffusion coefficient storage portion 66 is composed of a diffusion coefficient numerator storage portion 66a and a diffusion coefficient denominator storage portion 66b. The diffusion coefficient numerator storage portion 66a stores therein the numerator component of a diffusion coefficient. The diffusion coefficient denominator storage portion 66b stores therein the denominator component of the diffusion coefficient. The diffusion coefficient indicates the proportion of the quantization error generated by calculation in the quantization error calculation portion 64 to be apportioned to a yet-to-be quantized pixel.

The accumulative error calculation portion 67 is composed of a multiplier 67a, an adder 67b, and a divider 67c. In the multiplier 67a serving as multiplication means, among the quantization errors stored in the error storage portion 65, one to be apportioned to a pixel to be quantized next has been read out, and simultaneously the value of the numerator component of the diffusion coefficient corresponding to the quantization error has been read out from the diffusion coefficient numerator storage portion 66a. The quantization errors and the value of numerator component of the diffusion coefficient which are read out are multiplied.

In the adder 67b serving as second addition means, the multiplication results produced by the multiplier 67a are added to one another. In the divider 67c serving as division means, the addition result produced by the adder 67b, namely, the sum total of the multiplication results produced by the multiplier 67a for a pixel to be quantized next, is divided by the value of the denominator component of the diffusion coefficient stored in the diffusion coefficient denominator storage portion 66b. The division result is outputted to the adder 61 as an accumulative error for the pixel to be quantized next.

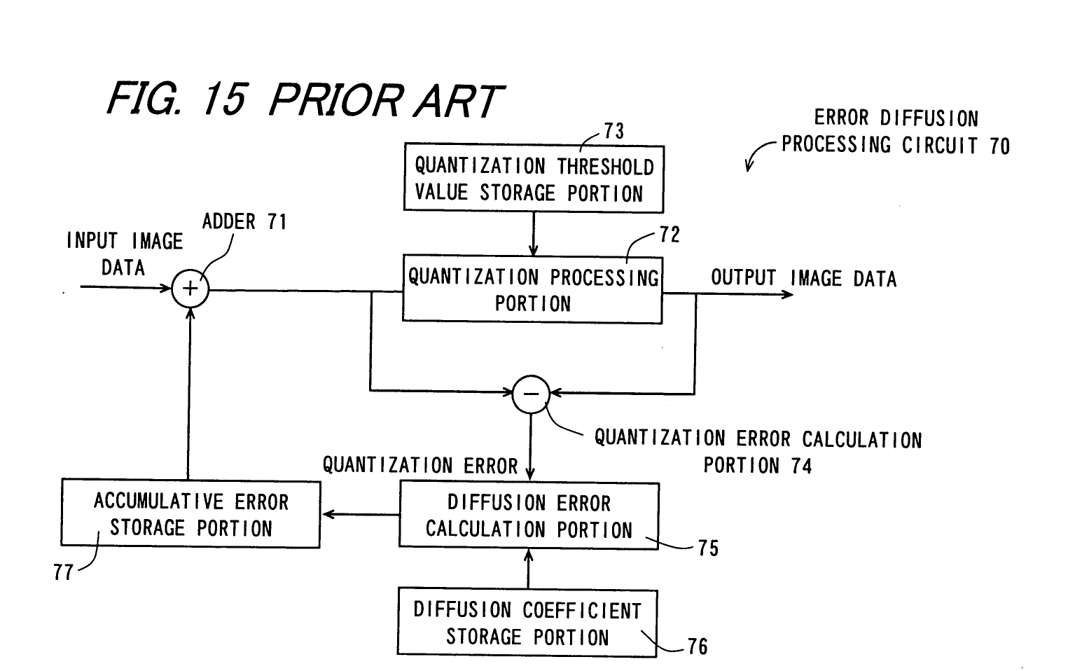

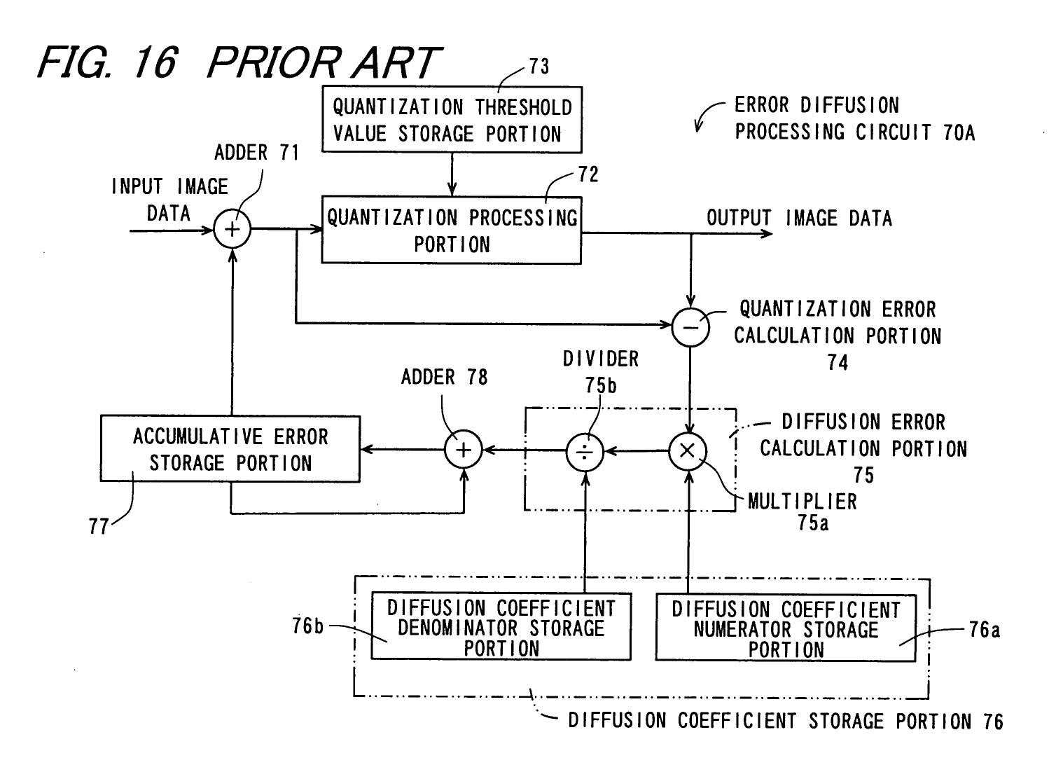

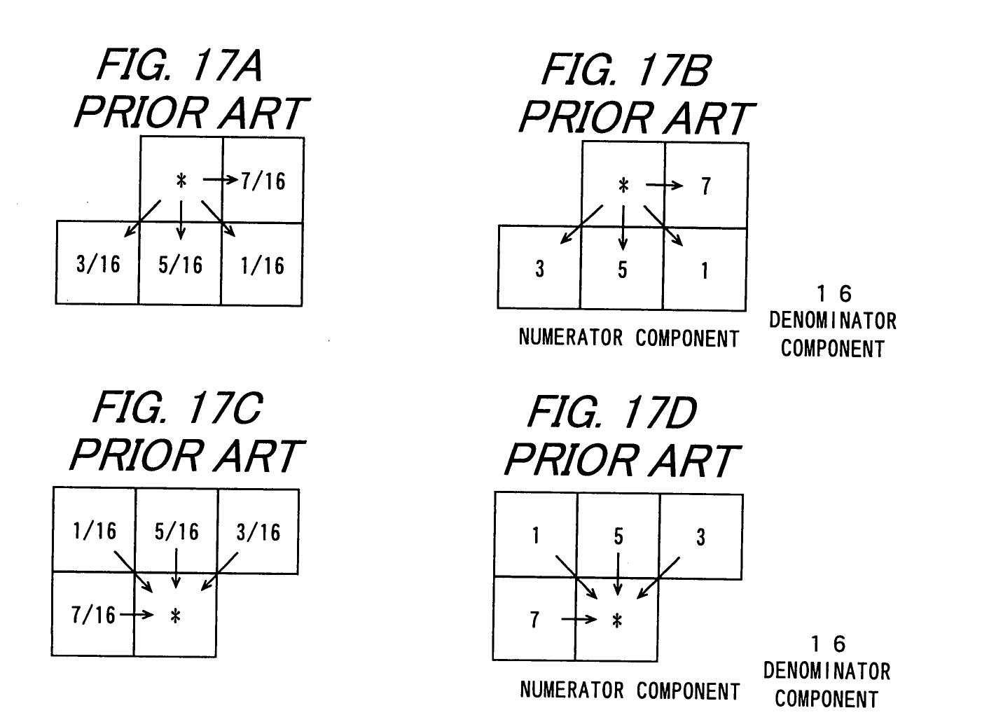

As shown in FIG. 15, in the first related art, every time a single pixel is quantized, the quantization error E(n) and the diffusion coefficient are multiplied with each other to generate a diffusion error to be distributed to an unprocessed pixel constituting an input image, and, through necessary arithmetic operations (multiplication and division), the resultant data is stored in the accumulative error storage portion 77. Then, at the time of quantizing the next pixel, the diffusion error distributed to the next pixel is read out from the accumulative error storage portion 77, and is then subjected to an addition operation to obtain an accumulative error therefor. On the other hand, in one embodiment of the invention thus far described, the quantization error E(n) is stored in advance in the error storage portion 65. At the time of quantizing the next pixel, the quantization error to be distributed to the next pixel and the value of the numerator component of the diffusion coefficient corresponding to the quantization error are multiplied with each other. After the multiplication results are added to one another, the sum total of the multiplication results, namely, the addition result, is divided by the value of the denominator component of the diffusion coefficient. The division result is taken as an accumulative error.

Specifically, assuming that the numerator component of the diffusion coefficient is aij and that the denominator component thereof is A, then the accumulative error D can be obtained by calculation using the following equation (4).

$$D = \frac{1}{A} \sum ( E ( n ) \times aij ) \qquad ( 4 )$$

Even if a numerical value obtained as a result of the arithmetic operation using the equation (4) has the number of decimal places, all digits to the right of the decimal point can be discarded or rounded off. In either case, it never occurs that the discarded or rounded-off values are accumulated that will eventually cause the result to be widely different from the original quantization error. This makes it possible to output satisfactory image data in which the tone reproducibility of the low-density and high-density regions is significantly improved.

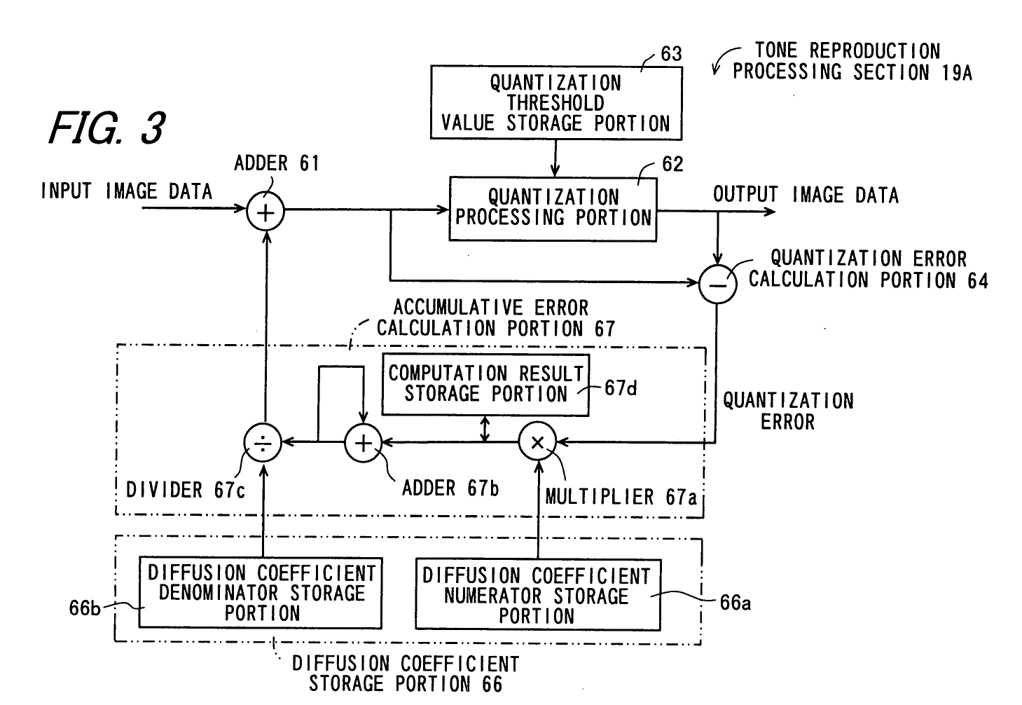

FIG. 3 is a block diagram showing a tone reproduction processing section 19A of a second example included in the image processing apparatus 10 according to another embodiment of the invention. The tone reproduction processing section 19A is composed of an adder 61, a quantization processing portion 62, a quantization threshold value storage portion 63, a quantization error calculation portion 64, a diffusion coefficient storage portion 66, and an accumulative error calculation portion 67.

In the adder 61, a pixel value representing the pixel density of input image data and an accumulative error generated by calculation in the accumulative error calculation portion 67 are added to each other. In the quantization processing portion 62, the pixel value added with the accumulative error by the adder 61 is quantized in accordance with a quantization threshold value stored in the quantization threshold value storage portion 63, whereby a quantization value for a pixel constituting output image data is obtained. The quantization error calculation portion 64 serves as a subtracter and calculates the difference between the pixel value added with the accumulative error by the adder 61 and the quantization value obtained by quantizing the pixel value in the quantization processing portion 62 as a quantization error. The resultant quantization error is outputted to the accumulative error calculation portion 67.

The diffusion coefficient storage portion 66 is composed of a diffusion coefficient numerator storage portion 66a and a diffusion coefficient denominator storage portion 66b. The diffusion coefficient numerator storage portion 66a stores therein the numerator component of a diffusion coefficient. The diffusion coefficient denominator storage portion 66b stores therein the denominator component of the diffusion coefficient. The diffusion coefficient indicates the proportion of the quantization error generated by calculation in the quantization error calculation portion 64 to be distributed to a yet-to-be quantized pixel.

The accumulative error calculation portion 67 is composed of a multiplier 67a, an adder 67b, a divider 67c, and a computation result storage portion 67d. In the multiplier 67a, the quantization error outputted from the quantization error calculation portion 64 and the value of each numerator component of the diffusion coefficient read out from the diffusion coefficient numerator storage portion 66a are multiplied with each other. The multiplication result produced by the multiplier 67a is stored in the computation result storage portion 67d.

In the adder 67b, among the multiplication results stored in the computation result storage portion 67d, multiplication results corresponding to a pixel to be quantized next are read out and added to one another to obtain a sum total. In the divider 67c, the sum total produced by the adder 67b is divided by the value of the denominator component of the diffusion coefficient stored in the diffusion coefficient denominator storage portion 66b. The division result is outputted to the adder 61 as an accumulative error for the pixel to be quantized next.

In any of the embodiments thus far described, the divider 67c may be designed to perform division operations under the condition that a quantization error is expressed by a binary number, and the denominator component of a diffusion coefficient is expressed by 2 raised to the n-th power (n represents an integer). In this case, a bit other than low-order n bits is extracted to determine a division result.

Moreover, the error diffusion method is not limited to binary error diffusion, but may be of multi-value error diffusion such as 4-value and 16-value error diffusion. Otherwise, a plurality of groups of the numerator component of a diffusion coefficient may be prepared for use. In this case, the numerator components are selectable depending upon a random number in use or a region discrimination result.

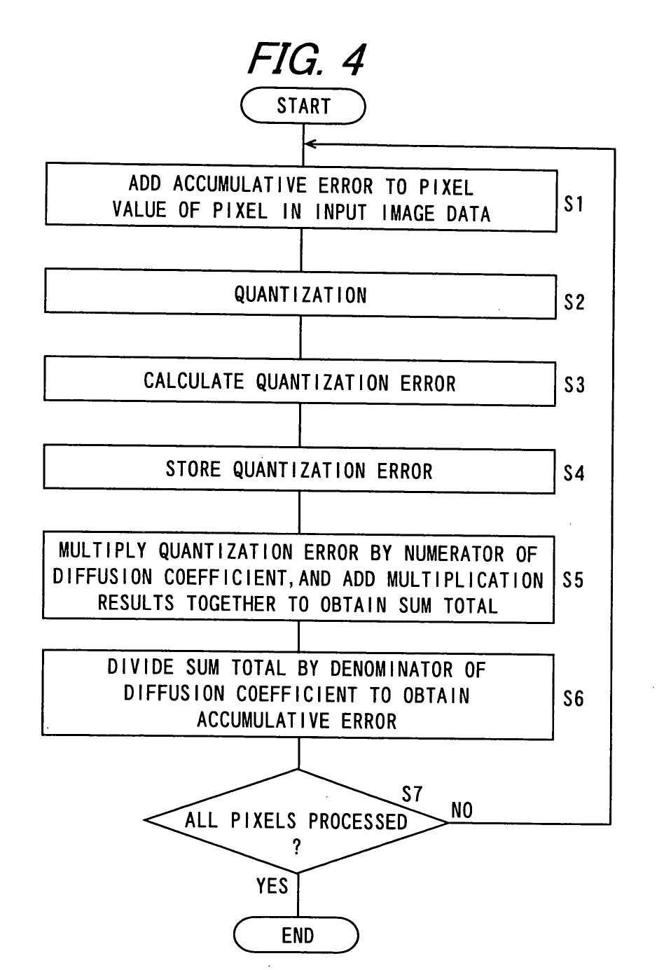

FIG. 4 is a flow chart for explaining a method of image processing according to still another embodiment of the invention. The image processing is started in accompaniment with an error diffusion process in the tone reproduction processing required for generating output image data.

In Step S1, an accumulative error is added to a pixel value representing the pixel density of input image data. In Step S2, the pixel value added with the accumulative error is quantized to obtain a quantization value for a pixel constituting output image data. In Step S3, the difference between the pixel value added with the accumulative error and the quantization value obtained by quantizing the pixel value is calculated as a quantization error. In Step S4, the quantization error thus obtained is stored in the storage portion.

In Step S5, among the quantization errors stored in the storage portion, one to be distributed to a pixel to be quantized next is determined, and this quantization error and the value of the numerator component of the diffusion coefficient corresponding to the quantization error are multiplied with each other. The multiplication results are added to one another to obtain a sum total. In Step S6, the sum total is divided by the value of the denominator component of the diffusion coefficient, whereby an accumulative error is generated. In Step S7, a check is made for whether all of the pixels have been quantized or not. If not, the procedure will return to Step S1. If it is found that all of the pixels have been quantized, the procedure will come to an end.

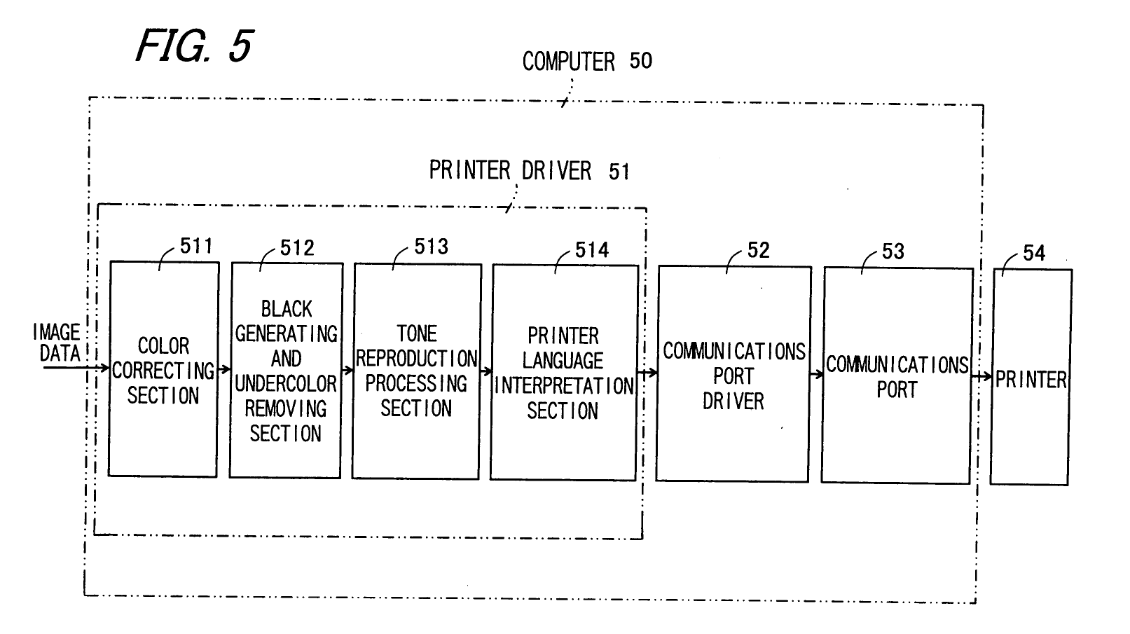

FIG. 5 is a view showing the configuration of a printer driver 51 and a computer 50 including the printer driver 51 according to yet another embodiment of the invention. The computer 50 is composed of the printer driver 51, a communications port driver 52, and a communications port 53. The computer 50 is connected to a printer 54 acting as an image outputting device.

Alternatively, the above-described image processing method may be accomplished by means of software such as an application program that is executable by the computer 50. In this case, the software for performing error diffusion processing is incorporated in the computer 50 as the printer driver 51. The printer driver 51 is composed of a color correcting section 511, a black generating and undercolor removing section 512, a tone reproduction processing section 513, and a printer language interpretation section 514.

In the computer 50, image data generated by executing a variety of application programs is subjected to the above-described processing in the color correcting section 511, the black generating and undercolor removing section 512, and the tone reproduction processing section 513 successively in the order named, Especially, the tone reproduction processing section 513 has a role to perform such error diffusion processing as illustrated in FIG. 4. The image data having undergone the error diffusion processing in the tone reproduction processing section 513 is converted into printer language by the printer language interpretation section 514, and is then transmitted to the printer 54 via the communications port driver 52 and the communications port 53, which is of a data communication interface such as RS 232C (Recommended Standard 232 version C) and LAN (Local Area Network). The printer 54 is designed to output an image in accordance with the image data transmitted from the computer 50. Note that the printer 54 may be built as a digital multi-function machine that combines the functions of a copier, a facsimile, and so forth.

Moreover, in the invention, the image processing method may be provided in the form of data recorded on a computer-readable recording medium for providing a program to allow the computer 50 to execute an image processing function accompanied by error diffusion for minimizing errors caused by discarding fractional parts in integer arithmetic operations, as described earlier. This makes it possible to enhance the availability of the image processing method by realizing a portable recording medium on which the image processing program is recorded for performing image processing using the error diffusion method that will achieve remarkably improved tone reproducibility in the low-density and high-density regions.

With consideration given to the computer-based operation, the recording medium may preferably be a program medium such as a memory (not illustrated), for instance ROM (Read Only Memory). The recording medium may also be a program medium such as that which is inserted into and read out by a program reading device acting as an external storage device (not illustrated).

Specifically, in a case where the program medium is a recording medium designed to be separable from the main unit, the preferred examples include: a tape such as a magnetic tape and a cassette tape; a magnetic disk such as a floppy disk and a hard disk; an optical disk such as a CD-ROM (Compact Disk Read Only Memory), an MO (Magneto Optical Disk), an MD (Mini Disc) and a DVD (Digital Versatile Disk); and a card such as an IC (Integrated Circuit) card, a memory card and an optical card. It is also possible to use a recording medium in which a program is stored in a fixed form, for instance a semiconductor memory such as a mask ROM, an EPROM (Erasable Programmable Read Only Memory), an EEPROM (Electrically Erasable Programmable Read Only Memory) and a flash ROM.

In any case, it is essential only that the program recorded on the recording medium be accessible and executable under the control of CPU. For example, the program is read out from the recording medium, and is then downloaded into a non-illustrated program storage area of the computer, whereupon the downloaded program is ready for execution. In this case, a program for downloading the target program is stored in advance in the main unit.

Moreover, in a case where the computer has a system configuration which permits connection with a communication network including Internet, by employing a recording medium capable of recording programs flexibly, it is possible to download a target program via a communication network. In the case of downloading a program via a communication network, a program for downloading the target program may be stored in advance in the main unit or may be installed from another recording medium.

The program recorded on a recording medium such as mentioned hereinabove is read out by a program reading device mounted in an image forming apparatus such as a digital color image forming apparatus or in a computer system. In accordance with the read-out program, the above-described image processing is carried out.

Note that the computer system thus far described is composed of an image input device such as a flat bed scanner, a film scanner and a digital camera; a computer for performing various operations including the above-described image processing by downloading a predetermined program; an image display device for indicating computer-based processing results, such as CRT (Cathode Ray Tube) display or liquid crystal display; a printer for putting out the computer-based processing results on a paper sheet; and a network card or a modem acting as communication means for permitting connection with a server or the like via a network.

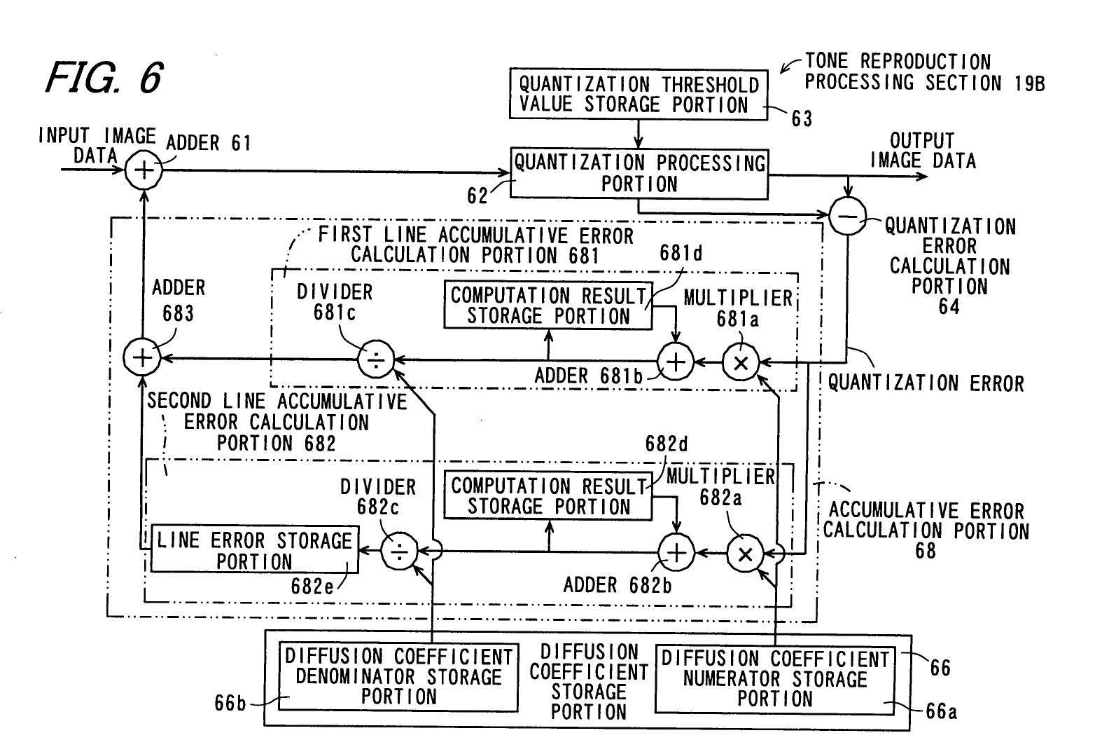

FIG. 6 is a block diagram showing a tone reproduction processing section 19B of a third example included in the image processing apparatus 10 according to yet another embodiment of the invention. The tone reproduction processing section 19B is composed of an adder 61, a quantization processing portion 62, a quantization threshold value storage portion 63, a quantization error calculation portion 64, a diffusion coefficient storage portion 66, and an accumulative error calculation portion 68. The tone reproduction processing section 19B shown in FIG. 6 is basically the same as the tone reproduction processing section 19A that shown in FIG. 3, but its accumulative error calculation portion 68 is configured differently from the accumulative error calculation section 67.

In the adder 61, a pixel value representing the pixel density of input image data and an accumulative error generated by calculation in the accumulative error calculation portion 68 are added to each other. In the quantization processing portion 62, the pixel value added with the accumulative error by the adder 61 is quantized in accordance with a quantization threshold value stored in the quantization threshold value storage portion 63, whereby a quantization value for a pixel constituting output image data is obtained. The quantization error calculation portion 64 serves as a subtracter and calculates the difference between the pixel value added with the accumulative error by the adder 61 and the quantization value obtained by quantizing the pixel value in the quantization processing portion 62 as a quantization error. The resultant quantization error is outputted to the accumulative error calculation portion 68.

The diffusion coefficient storage portion 66 is composed of a diffusion coefficient numerator storage portion 66a and a diffusion coefficient denominator storage portion 66b. The diffusion coefficient numerator storage portion 66a stores therein the numerator component of a diffusion coefficient. The diffusion coefficient denominator storage portion 66b stores therein the denominator component of the diffusion coefficient. The diffusion coefficient indicates the proportion of the quantization error generated by calculation in the quantization error calculation portion 64 to be distributed to a yet-to-be quantized pixel.

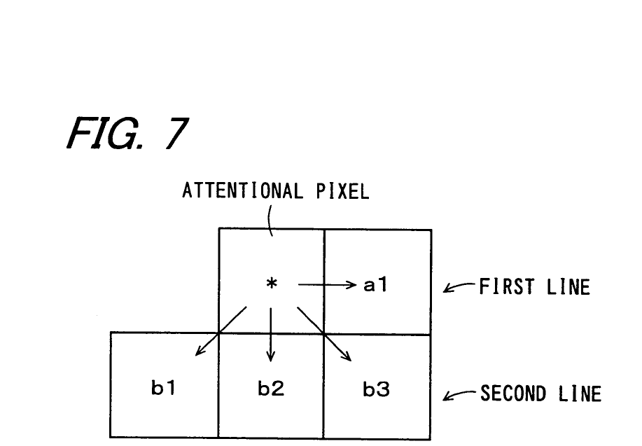

FIG. 7 is a view of assistance in explaining diffusion coefficients stored in the diffusion coefficient storage portion 66 shown in FIG. 6. For example, an input image is composed of plural lines each including plural pixels. The first pixel in the first line is quantized at the very beginning, and subsequently neighboring pixels of the same line are quantized one after another. Upon completion of quantization for all of the pixels included in a single line, the pixels of the next line are quantized one after another.

Of plural error diffusion lines including pixels to which the quantization error in a pixel included in a quantization line including pixels to be quantized, a line including a pixel to be quantized first is designated as the first line, the next line is designated as the second line, and a line next to the second line is designated as the third line. In this way, a number is assigned to each line. In a diffusion coefficient matrix shown in FIG. 7, a pixel to which attention is drawn (which is called “current pixel” hereinafter), namely, a pixel to be quantized, is included in the first line.

The diffusion coefficients are arranged in the form of a diffusion coefficient matrix having lines corresponding to the error diffusion lines. The diffusion coefficient matrix shown in FIG. 7 indicates the position of the current pixel which is defined as an origin, the positions of other pixels (to which the quantization error in the attentional pixel is distributed) relatively to the origin, and the proportion of the quantization error to be distributed to the pixel at the relative position, namely, diffusion coefficients.

As a diffusion coefficient for distributing the quantization error to the pixel in the first line, a diffusion coefficient a1 is located on the right-hand side of the current pixel. As diffusion coefficients for distributing the quantization error to the pixels of the second line, a diffusion coefficient b1 is located at the lower left of the current pixel, a diffusion coefficient b2 is located immediately below the current pixel, and a diffusion coefficient b3 is located at the lower right of the current pixel.

The pixels are given diffusion error allocation individually on the basis of their respective diffusion coefficients. The diffusion coefficient numerator storage portion 66a stores therein the values for the numerator of the diffusion coefficient represented by the fraction, whereas the diffusion coefficient denominator storage portion 66b stores therein the value for the denominator of the diffusion coefficient represented by the fraction. Note that the denominator is common to all of the diffusion coefficients in use.

Referring to FIG. 6, the accumulative error calculation portion 68 is composed of a first line accumulative error calculation portion 681, a second line accumulative error calculation portion 682, and an adder 683.

The first line accumulative error calculation portion 681 is composed of a multiplier 681a, an adder 681b, a divider 681c, and a computation result storage portion 681d. In the first line accumulative error calculation portion 681, with respect to the first line, the sum total of the diffusion errors, obtained on the basis of the diffusion coefficients in the first line of the diffusion coefficient matrix shown in FIG. 7, is generated by calculation on a pixel-by-pixel basis.

In the multiplier 681a, the quantization error generated by calculation in the quantization error calculation portion 64 and, of the numerator components of the diffusion coefficient stored in the diffusion coefficient numerator storage portion 66a, one corresponding to the first line of the diffusion coefficient matrix are multiplied with each other, so as to determine an error diffusion numerator amount. In the adder 681b, with respect to the first line, the multiplication result produced by the multiplier 681a, namely, the error diffusion numerator amount, and the addition result stored in the computation result storage portion 681d for storing therein addition results produced by the adder 681b are added to each other, on a pixel-by-pixel basis. The computation result storage portion 681d is a memory for storing, namely, recording, therein the summed error diffusion numerator amount produced by the adder 681b, first line pixel by first line pixel.

With respect to a single given pixel in the first line, upon completion of addition for all of the error diffusion numerator amounts, each of which has been obtained by multiplying the quantization error in the pixel included in the quantization line by the value of each numerator component of the diffusion coefficient corresponding to the first line, in the divider 681c, the summed error diffusion numerator amount produced by the adder 681b is divided by the value of the denominator component of the diffusion coefficient stored in the diffusion coefficient denominator storage portion 66b. The first line accumulative error calculation portion 681 outputs the division result produced by the divider 681c as a line accumulative error, first line pixel by first line pixel.

The computation result storage portion 681d is a memory for storing therein the error diffusion numerator amount temporarily. Specifically, with respect to a single given pixel in the first line, all of the error diffusion numerator amounts, obtained on the basis of the numerator components of the diffusion coefficient corresponding to the first line of the diffusion coefficient matrix, are added to one another. The addition result is kept stored in the computation result storage portion 681d until a division operation is performed thereon. Thus, the computation result storage portion 681d is required to have a storage capacity large enough to hold as many error diffusion numerator amounts as the number of the diffusion coefficients corresponding to the first line of the diffusion coefficient matrix. In the diffusion coefficient matrix shown in FIG. 7, since the number of the diffusion coefficients in the first line is 1, it follows that the computation result storage portion 681d is required to have enough capacity for one error diffusion numerator amount.

The second line accumulative error calculation portion 682 is composed of a multiplier 682a, an adder 682b, a divider 682c, a computation result storage portion 682d, and a line error storage portion 682e. The second line accumulative error calculation portion 682 generates the sum total of diffusion errors obtained on the basis of the diffusion coefficients corresponding to the second line of the diffusion coefficient matrix shown in FIG. 7, second line pixel by second line pixel.

In the multiplier 682a, the quantization error generated by calculation in the quantization error calculation portion 64 and, of the numerator components of the diffusion coefficient stored in the diffusion coefficient numerator storage portion 66a, one corresponding to the second line of the diffusion coefficient matrix are multiplied with each other, so as to determine an error diffusion numerator amount. In the adder 682b, with respect to the second line, the multiplication result produced by the multiplier 682a, namely, the error diffusion numerator amount, and the addition result stored in the computation result storage portion 682d for storing therein addition results produced by the adder 682b are added to each other, on a pixel-by-pixel basis. The computation result storage portion 682d is a memory for storing, namely, recording, therein the summed error diffusion numerator amount produced by the adder 682b, second line pixel by second line pixel.

With respect to a single given pixel in the second line, upon completion of addition for all of the error diffusion numerator amounts, each of which has been obtained by multiplying the quantization error in the pixel included in the quantization line by the value of each numerator component of the diffusion coefficient corresponding to the second line, in the divider 682c, the summed error diffusion numerator amount produced by the adder 682b is divided by the value of the denominator component of the diffusion coefficient stored in the diffusion coefficient denominator storage portion 66b. In other words, in the divider 682c, the sum total of the error diffusion numerator amounts, obtained as a result of distribution of the quantization error from the pixel in the first line to a single given pixel in the second line, is divided by the value of the denominator component of the diffusion coefficient stored in the diffusion coefficient denominator storage portion 66b.

The computation result storage portion 682d is a memory for storing therein the error diffusion numerator amount temporarily. Specifically, with respect to a single given pixel in the second line, all of the error diffusion numerator amounts, obtained on the basis of the numerator components of the diffusion coefficient corresponding to the second line of the diffusion coefficient matrix, are added to one another. The addition result is kept stored in the computation result storage portion 682d until a division operation is performed thereon. Thus, the computation result storage portion 682d is required to have a storage capacity large enough to store as many error diffusion numerator amounts as the number of the diffusion coefficients in the second line of the diffusion coefficient matrix. In the diffusion coefficient matrix shown in FIG. 7, since the number of the diffusion coefficients in the second line is 3, it follows that the computation result storage portion 682d is required to have enough capacity for three error diffusion numerator amounts.

The line error storage portion 682e is a memory for storing, namely, recording, therein the division result produced by the divider 682c, as a line accumulative error. Specifically, the line error storage portion 682e holds the line accumulative error, namely, the sum total of the diffusion errors distributed from the quantization error in the pixel of the first line, second line pixel by second line pixel. For example, the line error storage portion 682e is composed of a FIFO (First-In First-Out) type memory. The line error storage portion 682e is, with respect to a single pixel in the second line, required to keep the line accumulative error for the pixel stored therein between the instant when all of the diffusion errors distributed from the pixel of the quantization line are distributed and the instant when the pixel is quantized.

Moreover, in the line error storage portion 682e, after the line accumulative error stored first is read out, a new division result produced by the divider 682c is stored as a new line accumulative error. Therefore, the line error storage portion 682e is required to have a storage capacity large enough to store as many line accumulative errors as the number of pixels ranging from one subsequent to the pixel corresponding to the read-out line accumulative error to one corresponding to a newly stored line accumulative error, that is; the number of pixels included in a single line. If the pixel number varies from line to line, the line accumulative error storage capacity of the line error storage portion 682e needs to be determined in reference to the maximum number of pixels included in a single line.

The second line accumulative error calculation portion 682 outputs, among the line accumulative errors stored in the line error storage portion 682e, a line accumulative error corresponding to a pixel to be quantized next. In the adder 683, with respect to the pixel to be quantized next, the line accumulative error outputted from the first line accumulative error calculation portion 681 and the line accumulative error outputted from the second line accumulative error calculation portion 682 are added to each other. The addition result is inputted to the adder 61 as an accumulative error for the pixel to be quantized next.

For example, the memory such as the quantization threshold value storage portion 63, the diffusion coefficient storage portion 66, the computation result storage portion 681d, the computation result storage portion 682d, and the line error storage portion 682e, is included in a CPU incorporated in the image processing apparatus 10. The memory, which is used to store data for use in CPU-controlled processing as well as programs executed by the CPU, is realized by the use of a memory device such as a semiconductor memory.

For example, the adder 61 is defined as the first addition means. For example, the quantization processing portion 62 is defined as quantization processing means. For example, the quantization error calculation portion 64 is defined as quantization error calculation means. For example, the multipliers 681a and 682a are defined as multiplication means. For example, the adders 681b and 682b are defined as the second addition means. For example, the dividers 681c and 682c are defined as division means. For example, the first line accumulative error calculation portion 681 and the second line accumulative error calculation portion 682 are defined as line accumulative error calculation means. For example, the adder 683 is defined as the third addition means.

According to the first related art, in the error diffusion processing circuit 70 shown in FIG. 15 for instance, every time a single pixel is quantized, the quantization error E(n) and the diffusion coefficient are multiplied with each other to generate a diffusion error to be distributed to an unprocessed pixel constituting input image data, and, through necessary arithmetic operations (multiplication and division), the resultant data is stored in the accumulative error storage portion 77. Then, at the time of quantizing the next pixel, the accumulative error having already been distributed to a pixel to which the quantization error in the pixel is distributed is read out from the accumulative error storage portion 77. By adding a newly-distributed diffusion error, the existing accumulative error is updated.

By way of contrast, in the tone reproduction processing section 19B shown in FIG. 6, the quantization error E(n) and the value of each numerator component of the diffusion coefficient are multiplied with each other. With respect to each of the pixels included in the error diffusion line, the sum total of the multiplication results obtained on the basis of the quantization error in the pixel included in the quantization line is divided by the value of the denominator component of the diffusion coefficient. Further, the division result is provided as a line accumulative error for each of the error diffusion line. Next, the sum total of the line accumulative errors is generated by calculation to obtain an accumulative error for a pixel to be quantized next.

Specifically, in the diffusion coefficient matrix shown in FIG. 7 for instance, assuming that the numerator component of the diffusion coefficient corresponding to the first line is a1, that the numerator component of the diffusion coefficient corresponding to the second line is aj, and that the denominator component of the diffusion coefficient is A, then the accumulative error D can be obtained by an arithmetic operation using the following equation (5).

$$D = \frac{1}{A} \sum ( E ( n ) \times ai ) + \frac{1}{A} \sum ( E ( n ) \times aj ) \qquad ( 5 )$$

Even if a numerical value obtained as a result of two division operations in the equation (5) has the number of decimal places, all digits to the right of the decimal point can be discarded, rounded up, or rounded off. In any case, the discarded or rounded-up values are no longer accumulated in a single error diffusion line. This is because, at the time of determining an accumulative error for the next current pixel, namely, the pixel to be quantized next, the sum of the products of the value of the numerator component of the diffusion coefficient and the quantization error provided for each of the error diffusion line is divided by the value of the denominator component of the diffusion coefficient. Hence, it never occurs that the accumulative error generated by calculation using the equation (5) is widely different from the original accumulative error, for which none of discard, rounding up, and rounding off of fractional parts is done.

Specifically, in a case where the quantization error and a certain numerator component of the diffusion coefficient are multiplied with each other, then the multiplication result is divided by the denominator component of the diffusion coefficient, and further the division results are added to one another, as many division errors attendant upon division operations as the number of the numerator components of the diffusion coefficient are accumulated. However, by dividing the sum total of the multiplication results obtained for each of the error diffusion lines, it is possible to reduce division error accumulation successfully.

As described above, in order to derive the accumulative error on the basis of the quantization error, the diffusion coefficient is divided into a numerator component and a denominator component, and the sum of the products of the quantization error and each numerator component of the diffusion coefficient obtained for each of the error diffusion lines is divided. The division operation is performed sequentially pixel by pixel. In this way, it is possible to suppress accumulation of division errors that arise every time a single quantization error is diffused to neighboring pixels, and thereby output image data in which the tone reproducibility of the low-density and high-density regions is improved.

In the second line accumulative error calculation portion 682 disposed in the tone reproduction processing section 19B shown in FIG. 6, with respect to a single given pixel, upon completion of addition for all of the error diffusion numerator amounts obtained on the basis of the numerator components of the diffusion coefficient corresponding to the second line, the summed diffusion error numerator amount is divided by the denominator component of the diffusion coefficient. The division result is stored in the line error storage portion 682e as a line accumulative error. Thus, when the summed diffusion error numerator amount is divided, the addition result stored in the computation result storage portion 682d is deleted, so that the division result, namely, the line accumulative error, may be stored in the line error storage portion 682e. Since the line accumulative error is smaller in bit number than the addition result, as compared with the computation result storage portion 67d of the tone reproduction processing section 19A shown in FIG. 3, the storage capacity can be reduced successfully.

For example, assuming that the pixel value, the denominator component of the diffusion coefficient, and the numerator component thereof are each 8 bits, and that the diffusion coefficient matrix shown in FIG. 7 is used, then the 8-bit quantization error multiplied by the 8-bit numerator component of the diffusion coefficient equals 16 bits. In the diffusion coefficient matrix shown in FIG. 7, the second line includes three diffusion coefficients, and therefore three multiplication results are added to each other. With consideration given to production of a carry, the addition result reaches 18 bits at the maximum. The addition result is stored in the computation result storage portion 682d.

The addition result, stored in the computation result storage portion 682d for storing therein the addition result on the second-line pixel, is read out in preparation for a division operation at the time when the three multiplication results are added to each other. Thus, the computation result storage portion 682d is required to have a storage capacity of 36 bits for holding the addition result on three pixels. On the other hand, the computation result storage portion 681d for storing therein the addition result on the first-line pixel is required to have a storage capacity of 16 bits. This is because the number of the diffusion coefficients in the first line is only one, that is; the multiplication result is only one, and thus no addition operation is performed.

The 18-bit addition result divided by the 8-bit denominator component of the diffusion error equals 10 bits. This division result is stored in the line error storage portion 682e. The line error storage portion 682e is required to keep the division result, namely, the line accumulative error corresponding to a single given pixel, stored therein between the instant when all of the diffusion errors distributed from the pixel of the quantization line are distributed to a single pixel and the instant when the pixel is quantized. It will thus be seen that the line error storage portion 682e is required to hold as many line accumulative errors as the number of pixels in a single line, at the maximum. Assuming that the number of pixels included in a single line is g, then the storage capacity of the line error storage portion 682e needs to be determined in reference to 10×g bits. Since both the computation result storage portion 681d and the computation result storage portion 682d are relatively small in storage capacity, it follows that a necessary storage capacity of the tone reproduction processing section 19 shown in FIG. 6 depends mainly upon the storage capacity of the line error storage portion 682e. It is roughly estimated at 10 g bits.

On the other hand, in the computation result storage portion 67d of the tone reproduction processing section 19A shown in FIG. 3, as many multiplication results as the number of diffusion coefficients are obtained with respect to a single quantization error. These multiplication results need to be stored properly as a matter of course. Since these multiplication results correspond to different pixels respectively, it follows that the first multiplication result needs to be kept stored until the last multiplication result is obtained on a pixel-by-pixel basis.

For example, in the diffusion coefficient matrix shown in FIG. 7, the first distribution of the quantization error to a single given pixel takes place when the current pixel is located at the upper left of the pixel. The last distribution of the quantization error to the pixel takes place when the current pixel is located on the left-hand side of the pixel. In other words, under the condition that the number of pixels to be quantized is equivalent to a value obtained by adding 1 to the original number of pixels included in a single line, the computation result storage portion 67d is required to keep the multiplication result stored therein until all of the pixels are quantized. Since the number of diffusion coefficients is 4 in this case, if the number of pixels included in a single line is assumed to be g, then the necessary storage capacity of the tone reproduction processing section 19A shown in FIG. 3 is roughly estimated at 16×g×4 bits.

In this way, the tone reproduction processing section 198 shown in FIG. 6 can be made smaller in necessary storage capacity than the tone reproduction processing section 19A shown in FIG. 3.

FIG. 8 is a flow chart for explaining a method of image processing effected by the tone reproduction processing section 19B shown in FIG. 6. This image processing method is accomplished by executing a program stored in the memory under the control of the CPU incorporated in the color image processing apparatus 10, for instance. The image processing operation is started in accompaniment with an error diffusion process in the tone reproduction processing required for generating output image data.

In Step T1, an accumulative error is added to a pixel value representing the pixel density of input image data. In Step T2, the pixel value added with the accumulative error is quantized to obtain a quantization value for a pixel constituting output image data. In Step T3, the difference between the pixel value added with the accumulative error and the quantization value obtained by quantizing the pixel value is calculated as a quantization error.

In Step T4, the quantization error and the value of each numerator component of the diffusion coefficient are multiplied with each other. This multiplication operation is performed sequentially for each line to which the quantization error in a given pixel of a single line is distributed, that is; error-diffusion line by error-diffusion line. The multiplication result is then added to the addition result on the corresponding pixel stored in the computation result storage portion consisting of a memory. Each of the addition results is stored in the computation result storage portion as a new addition result. With respect to a pixel for which no addition result is stored, a numeral 0 is added to the multiplication result, and the resultant addition result is stored in the computation result storage portion. Alternatively, in a case where the computation result storage portion has a room in its storage capacity, a numeral 0 may be stored as an initial value pixel position by pixel position, or the multiplication result may be stored as it is without performing any addition operation.

In Step T5, the addition result, namely, the sum total of the multiplication results, is divided by the value of the denominator component of the diffusion coefficient on a line-by-line basis, that is; error-diffusion line by error-diffusion line. The division result is taken as a line accumulative error. In Step T6, with respect to a pixel to be quantized next, all of the line accumulative errors are summed to generate an accumulative error.

In Step T7, a check is made for whether all of the pixels constituting input image data have undergone error diffusion processing or not. If it is found that all of the pixels have been processed, the procedure will come to an end. If not, the procedure will return to Step T1 where an unprocessed pixel is subjected to error diffusion processing.

As described above, in order to derive the accumulative error on the basis of the quantization error, the diffusion coefficient is divided into a numerator component and a denominator component, and the sum of the products of the quantization error and each numerator component of the diffusion coefficient obtained for each of the error diffusion lines is divided. The division operation is performed sequentially pixel by pixel. In this way, it is possible to suppress accumulation of division errors that arise every time a single quantization error is diffused to neighboring pixels, and thereby output image data in which the tone reproducibility of the low-density and high-density regions is improved.

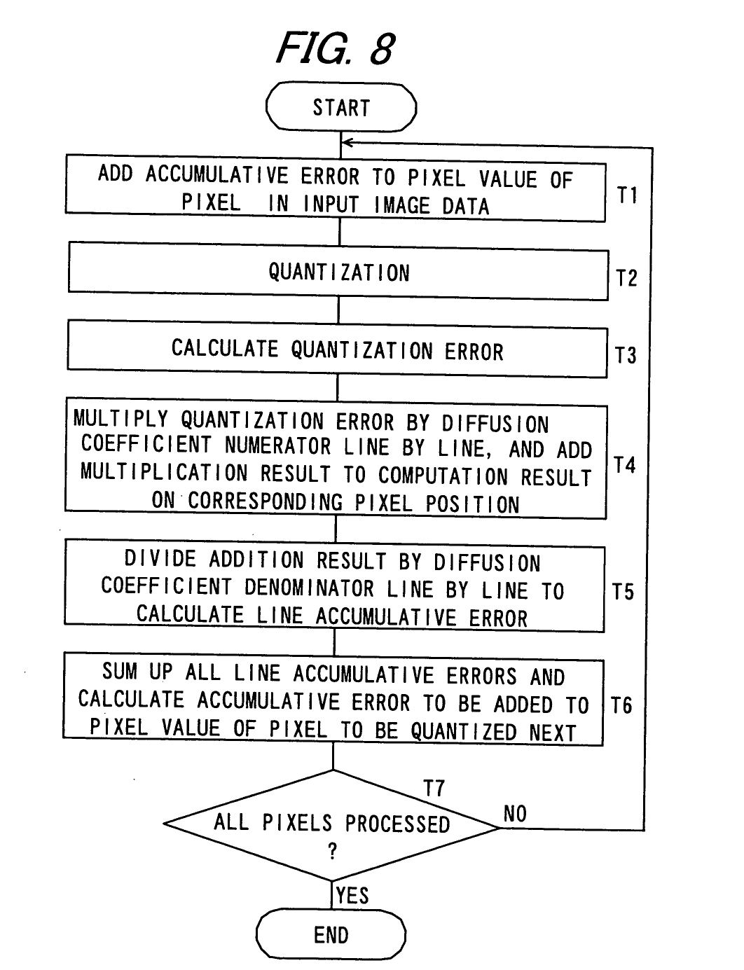

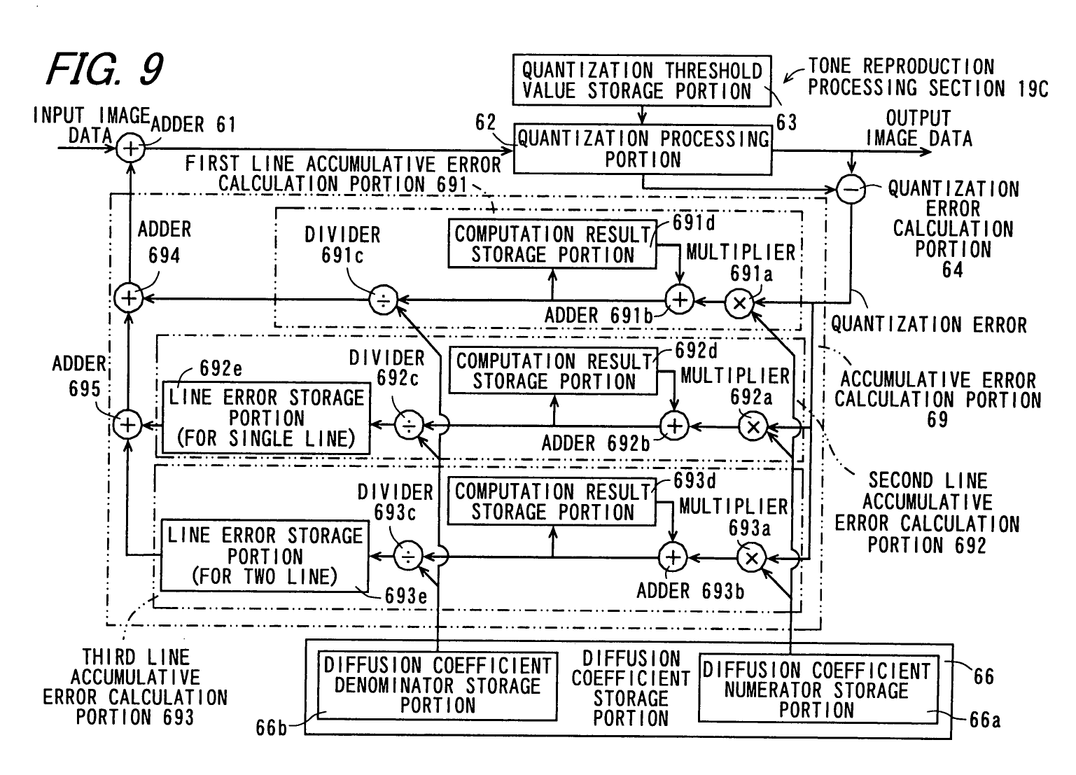

FIG. 9 is a block diagram showing a tone reproduction processing section 19C of a forth example included in the image processing apparatus 10 according to yet another embodiment of the invention. In contrast to the tone reproduction processing section 19B shown in FIG. 6 in which a quantization error in a single given pixel is diffused to the pixels of two error diffusion lines, the tone reproduction processing section 19C shown in FIG. 9 is so designed that the quantization error is diffused to the pixels of three error diffusion lines.

The tone reproduction processing section 19C is composed of an adder 61, a quantization processing portion 62, a quantization threshold value storage portion 63, a quantization error calculation portion 64, a diffusion coefficient storage portion 66, and an accumulative error calculation portion 69. The tone reproduction processing section 19C shown in FIG. 9 is basically the same as that shown in FIG. 6, but its accumulative error calculation portion 69 is configured differently from the accumulative error calculation portion 68. The adder 61, the quantization processing portion 62, the quantization threshold value storage portion 63, the quantization error calculation portion 64, and the diffusion coefficient storage portion 66 are the same as those shown in FIG. 6, and therefore the explanation thereof will be omitted.

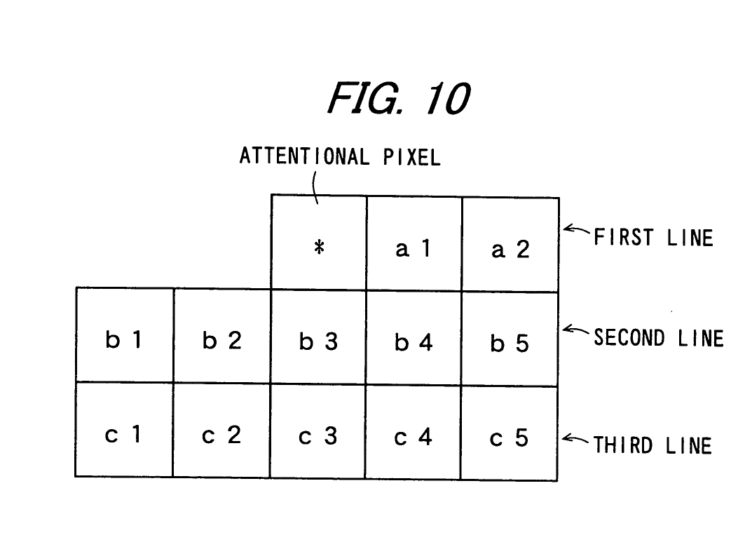

FIG. 10 is a view of assistance in explaining diffusion coefficients stored in the diffusion coefficient storage portion 66 shown in FIG. 9. The diffusion coefficients are arranged in the form of a diffusion coefficient matrix composed of three error diffusion lines. This diffusion coefficient matrix is, instead of the diffusion coefficient matrix shown in FIG. 7, used to allow the quantization error to be diffused to pixels in a wider range, for example, it is used to perform tone-oriented processing.

As diffusion coefficients for distributing the quantization error to the first-line pixel, a diffusion coefficient a1 is next to the current pixel, and a diffusion coefficient a2 is the next but one, as seen on the right-hand side. As diffusion coefficients for distributing the quantization error to the second-line pixel, first of all, a diffusion coefficient b3 is located immediately below the current pixel. Moreover, a diffusion coefficient b2 is next to the diffusion coefficient b3, and a diffusion coefficient b1 is the next but one, as seen on the left-hand side. Further, a diffusion coefficient b4 is next to the diffusion coefficient b3, and a diffusion coefficient b5 is the next but one, as seen on the right-hand side.

As diffusion coefficients for distributing the quantization error to the third-line pixel, a diffusion coefficient c1, a diffusion coefficient c2, a diffusion coefficient c3, a diffusion coefficient c4, and a diffusion coefficient c5 are located immediately below the diffusion coefficient b1, the diffusion coefficient b2, the diffusion coefficient b3, the diffusion coefficient b4, and the diffusion coefficient b5, respectively.

The diffusion error to be distributed to each of the pixels is determined according to the corresponding diffusion coefficient. The diffusion coefficient numerator storage portion 66a stores therein the values for the numerator of the diffusion coefficient represented by the fraction, whereas the diffusion coefficient denominator storage portion 66b stores therein the value for the denominator of the diffusion coefficient represented by the fraction. Note that the denominator is common to all of the diffusion coefficients in use.

Referring to FIG. 9, the accumulative error calculation portion 69 is composed of a first line accumulative error calculation portion 691, a second line accumulative error calculation portion 692, a third line accumulative error calculation portion 693, an adder 694, and another adder 695.

The first line accumulative error calculation portion 691 is composed of a multiplier 691a, an adder 691b, a divider 691c, and a computation result storage portion 691d. The constituent components mentioned just above correspond to the multiplier 681a, the adder 681b, the divider 681c, and the computation result storage portion 681d, respectively, that constitute the first line accumulative error calculation portion 681 shown in FIG. 6, and therefore the explanation thereof will be omitted. With respect to the first-line pixel to which the quantization error is distributed, the first line accumulative error calculation portion 691 calculates the sum total of the diffusion errors obtained on the basis of the diffusion coefficients corresponding to the first line of the diffusion coefficient matrix shown in FIG. 10 as a line accumulative error, pixel by pixel.

The second line accumulative error calculation portion 692 is composed of a multiplier 692a, an adder 692b, a divider 692c, a computation result storage portion 692d, and a line error storage portion 692e. The constituent components mentioned just above correspond to the multiplier 682a, the adder 682b, the divider 682c, the computation result storage portion 682d, and the line error storage portion 682e, respectively, that constitute the second line accumulative error calculation portion 682 shown in FIG. 6, and therefore the explanation thereof will be omitted. With respect to the second-line pixel to which the quantization error is distributed, the second line accumulative error calculation portion 692 calculates the sum total of the diffusion errors obtained on the basis of the diffusion coefficients corresponding to the second line of the diffusion coefficient matrix shown in FIG. 10 as a line accumulative error, pixel by pixel.

The third line accumulative error calculation portion 693 is composed of a multiplier 693a, an adder 693b, a divider 693c, a computation result storage portion 693d, and a line error storage portion 693e. With respect to the third-line pixel to which the quantization error is distributed, the third line accumulative error calculation portion 693 calculates the sum total of the diffusion errors obtained on the basis of the diffusion coefficients corresponding to the third line of the diffusion coefficient matrix shown in FIG. 10 as a line accumulative error, pixel by pixel.

The line error storage portion 693e is, like the line error storage portion 692e, formed of a FIFO type memory. However, the line error storage portions 693e and 692e are different from each other in duration of time for storing the line accumulative error distributed to each pixel. In the line error storage portion 693e, with respect to a single given pixel, the line accumulative error corresponding to the pixel needs to be stored between the instant when the line accumulative error is stored and the instant when the pixel is quantized.

Specifically, with respect to a single given pixel, at a point of time when the current pixel is located in a line two lines ahead of the present line, the line accumulative error obtained on the basis of the second-line diffusion coefficients has already been stored. Thus, the line accumulative error corresponding to the pixel needs to be kept stored until the pixel is quantized, that is; until all of the pixels belonging to two lines are quantized. In other words, the line error storage portion 693e is required to have a storage capacity large enough to hold the accumulative errors corresponding to two lines, that is; a storage capacity twice as large as that of the line error storage portion 692e. The other constituent components of the third line accumulative error calculation portion 693 are the same as the corresponding ones of the second line accumulative error calculation portion 692, and therefore the explanation thereof will be omitted.

In the adder 695, with respect to a pixel to be quantized next, the line accumulative error outputted from the second line accumulative error calculation portion 692 and the line accumulative error outputted from the third line accumulative error calculation portion 693 are added to each other. The addition result is inputted to the adder 694. In the adder 694, with respect to the pixel to be quantized next, the line accumulative error outputted from the first line accumulative error calculation portion 691 and the addition result produced by the adder 695 are added to each other. The addition result is inputted to the adder 61 as an accumulative error.

For example, the memory such as the quantization threshold value storage portion 63, the diffusion coefficient storage portion 66, the computation result storage portions 691d through 693d, and the line error storage portions 692e and 693e, is included in a CPU incorporated in the image processing apparatus 10. The memory, which is used to store data for use in CPU-controlled processing as well as programs executed by the CPU, is realized by the use of a memory device such as a semiconductor memory.

For example, the multipliers 691a through 693a are defined as multiplication means. For example, the adders 691b through 693b are defined as the second addition means. For example, the dividers 691c through 693c are defined as division means. For example, the first to third line accumulative error calculation portions 691 through 693 are defined as line accumulative error calculation means. For example, the adders 694 and 695 are defined as the third addition means.

In this way, even if the number of the error diffusion lines including pixels to which the quantization error in a single given pixel is diffused is increased, by increasing the number of the line accumulative error calculation portions for determining a line accumulative error by the number of the error diffusion lines, it is possible to obtain diffusion errors in a parallel manner, and thereby achieve high-speed processing.

A method of image processing effected by the tone reproduction processing section 19C shown in FIG. 9 conforms to that shown in the flow chart of FIG. 8, and therefore the explanation thereof will be omitted.

FIG. 11 is a block diagram showing a tone reproduction processing section 19D of a fifth example included in the image processing apparatus according 10 to yet another embodiment of the invention. This tone reproduction processing section 19D is composed of an adder 61, a quantization processing portion 62, a quantization threshold value storage portion 63, a quantization error calculation portion 64, a diffusion coefficient storage portion 66, and an accumulative error calculation portion 69. In the fifth example, its accumulative error calculation portion 69 is realized by making an improvement to the accumulative error calculation portion 69 of the fourth example in such a way that the storage capacity of the line error storage portion 693e is reduced. No explanation will be given as to the components that play the same or corresponding roles as in the fourth example.

In this example, the second line accumulative error calculation portion 692 further includes an adder 692f for adding the division result produced by the divider 692c to the line accumulative error generated by calculation in the third line accumulative error calculation portion 693. In the adder 692f, with respect to a single given pixel, after all of the multiplication results, obtained one after another on the basis of the numerator components of the diffusion coefficient corresponding to the second line, are added to one another by the adder 682b, followed by dividing the addition result in the divider 692c, then the division result and, among the line accumulative errors stored in the line error storage portion 693f, a line accumulative error corresponding to the pixel are added to each other. The addition result produced by the adder 692f is stored in the line error storage portion 692e.

The third line accumulative error calculation portion 693 includes the line error storage portion 693f instead of the line error storage portion 693e of the fourth example shown in FIG. 9. The line error storage portion 693f is, like the line error storage portion 693e, formed of a FIFO type memory. In the line error storage portion 693f, with respect to the third-line pixel to which the quantization error is distributed, the line accumulative error, namely, the sum total of the diffusion errors obtained on the basis of the third-line diffusion coefficients of the diffusion coefficient matrix shown in FIG. 10, is stored pixel by pixel.

The line error storage portions 693f and 693e are different from each other in number of line accumulative errors to be stored and in duration of time for storing the pixel-by-pixel line accumulative errors. The line error storage portion 693e stores therein ten line accumulative errors. With respect to a single given pixel, the corresponding line accumulative error is stored until the pixel is quantized. That is, in the line error storage portion 693e, the line accumulative error is kept stored until all of the pixels belonging to two lines are quantized.

On the other hand, the line error storage portion 693f stores therein five line accumulative errors. With respect to a single given pixel, the corresponding line accumulative error is kept stored until, in the adder 692f of the second line accumulative error calculation portion 692, among the line accumulative errors outputted from the line error storage portion 693f, a line accumulative error corresponding to the pixel is added. That is, in the line error storage portion 693f, the line accumulative error is kept stored until all of the pixels belonging to one line are quantized.

In the adder 694, with respect to a pixel to be quantized next, the line accumulative error outputted from the first line accumulative error calculation portion 691 and the line accumulative error outputted from the second line accumulative error calculation portion 692 are added to each other. The addition result is inputted to the adder 61 as an accumulative error.

For example, the line error storage portion 693f is defined as the first line error storage means. For example, the line error storage portion 692e is defined as the second line error storage means. For example, the adder 692f is defined as the fourth addition means.

As seen from the foregoing, in the adder 692f, since the division result produced by the divider 692c and the line accumulative error fed from the line error storage portion 693f are added to each other, there is a possibility that a carry comes about. Therefore, it is necessary for the line error storage portion 692e to hold addition results 1 bit larger than those stored in the line error storage portion 692e shown in FIG. 9. However, in the line error storage portion 693f, with respect to a single given pixel to which the quantization error is distributed on the basis of the third-line diffusion coefficients, the corresponding line accumulative error is kept stored until the pixels belonging to a single line are quantized. It is thus essential only that the line error storage portion 693f be given enough capacity for as many line accumulative errors as the number of pixels belonging to a single line. Eventually, the storage capacity of the line error storage portion 693f can be made approximately half the storage capacity of the line error storage portion 693e.

Conveniently, in contrast to the tone reproduction processing section 19C shown in FIG. 9 in which a division result and a line accumulative error corresponding to the following error diffusion line are not added to each other, in the tone reproduction processing section 19D shown in FIG. 11, the larger the number of error diffusion lines to which the quantization error is distributed, the smaller the memory capacity of the line error storage portion can be.

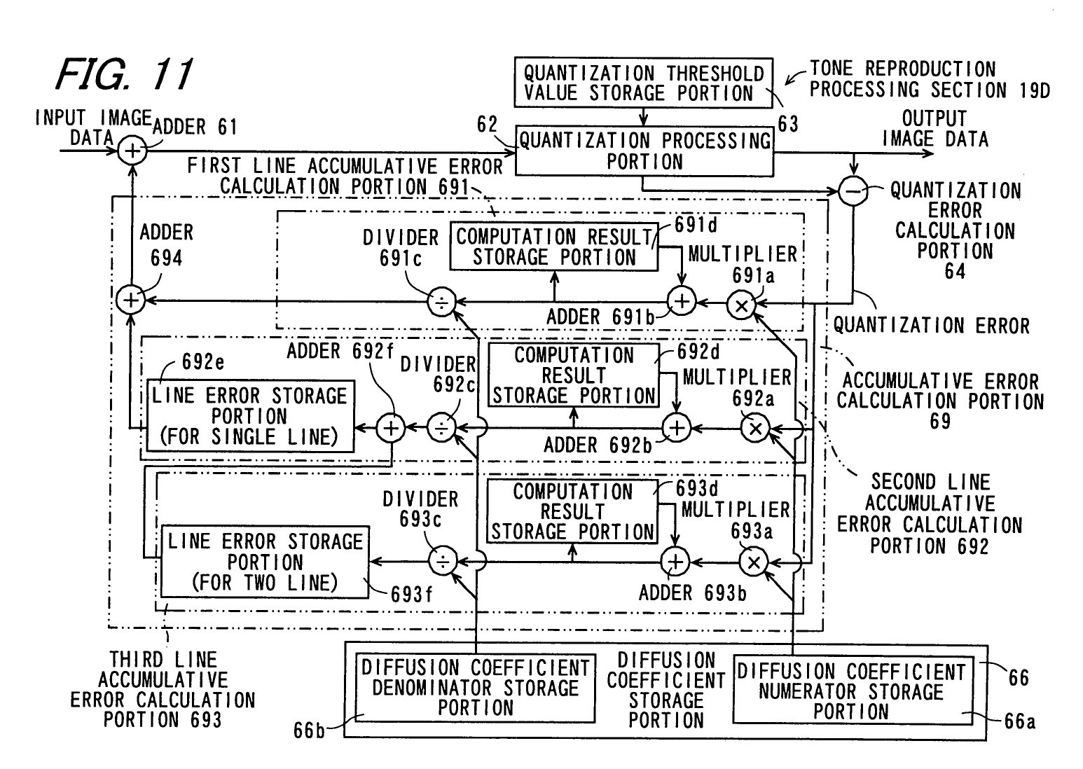

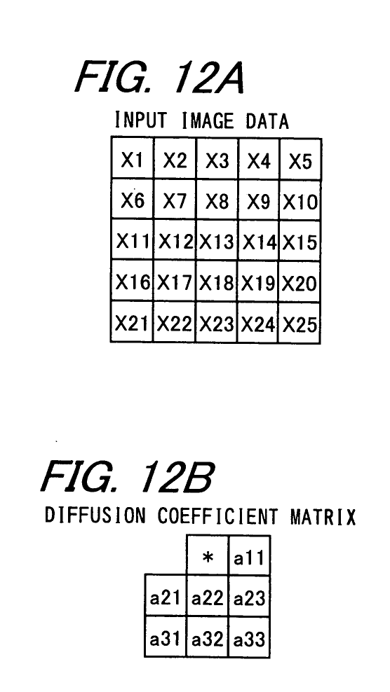

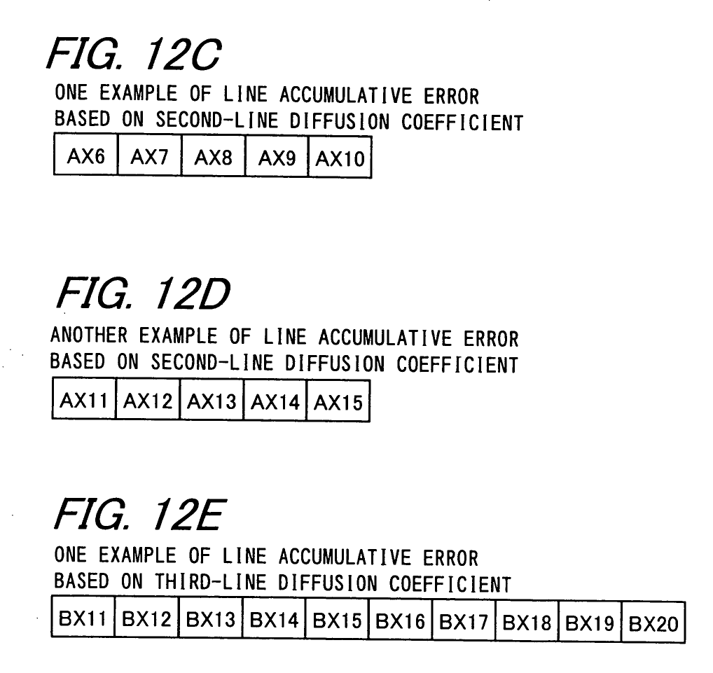

FIGS. 12A through 12E are views of assistance in explaining the storage capacity of the line error storage portion shown in FIGS. 9 and 11. FIG. 12A is a view for explaining one example of the arrangement of pixels constituting input image data. The image data is composed of 5×5 pixels, namely, five pixel lines each including five pixels. For example, the first line is composed of five pixels X1 to X5.

FIG. 12B is a view showing another example of the diffusion coefficient matrix arrangement. In this diffusion coefficient matrix, a region indicated by asterisk (*) corresponds to an current pixel, namely, a pixel to be quantized. Relative to the current pixel position, the other pixels, to which the quantization error attendant upon quantization of the current pixel is diffused, i.e. distributed, are positioned. Moreover, each of the pixel positions subjected to quantization-error diffusion is given a diffusion coefficient indicating the proportion of the quantization-error diffusion.

The uppermost line of the diffusion coefficient matrix corresponds to the first pixel line to which the quantization error in the current pixel is distributed. The current pixel position is marked with asterisk (*). On the right-hand side of the current pixel is located a diffusion coefficient all. The second line of the diffusion coefficient matrix corresponds to the second pixel line to which the quantization error in the current pixel is distributed. Included therein are three diffusion coefficients a21, a22, and a23. The diffusion coefficient a22 is located immediately below the current pixel, the diffusion coefficient a21 is next to the diffusion coefficient a22 on the left-hand side, and the diffusion coefficient a23 is next to the diffusion coefficient a22 on the right-hand side. The third line of the diffusion coefficient matrix corresponds to the third pixel line to which the quantization error in the current pixel is distributed. Included therein are three diffusion coefficients a31, a32, and a33. The diffusion coefficient a32 is located next but one to the current pixel in the downward direction, the diffusion coefficient a31 is next to the diffusion coefficient a32 on the left-hand side, and the diffusion coefficient a33 is next to the diffusion coefficient a32 on the right-hand side.

FIG. 12C is a view showing one example of the line accumulative error obtained on the basis of the second-line diffusion coefficients. The line accumulative errors AX6 to AX10 represent the sum of the diffusion errors that have been diffused to the pixels X6 to X10, respectively, on the basis of the second-line diffusion coefficients, in accompaniment with quantization of the pixels X1 to X5. The line accumulative errors AX6 to AX10 are stored in the line error storage portion 692e.

For example, the line accumulative error AX8 represents the sum of the diffusion errors resulting from diffusion of the quantization errors in three pixels X2 to X4 on the basis of the diffusion coefficients corresponding to the second line of the diffusion coefficient matrix. Specifically, assuming that the quantization errors produced in the pixels X2 to X4 upon quantization are E2 to E4, respectively, then a diffusion error derived from the pixel X2 is expressed as E2×a23, a diffusion error derived from the pixel X3 is expressed as E3×a22, and a diffusion error derived from the pixel X4 is expressed as E4×a21. By summing up these values, the line accumulative error AX8 is obtained.

The line accumulative error AX6 is kept stored in the line error storage portion 692e between the instant when the quantization error in the pixel X1 is diffused and the instant when the pixel X6 is quantized, that is; during the time while all of the pixels belonging to a single line are quantized. In accompaniment with quantization of the pixel X6, the line accumulative error AX6 is read out from the line error storage portion 692e. Thus, instead of the line accumulative error AX6, a newly-derived line accumulative error AX11 can be stored in that storage region.

FIG. 12D is a view showing another example of the line accumulative error obtained on the basis of the second-line diffusion coefficients. The line accumulative errors AX11 to AX15 represent the sum of the diffusion errors that have been diffused to the pixels X1 to X15, respectively, on the basis of the second-line diffusion coefficients, in accompaniment with quantization of the pixels X6 to X10.

FIG. 12E is a view showing one example of the line accumulative error obtained on the basis of the third-line diffusion coefficients. The line accumulative errors BX11 to BX20 represent the sum of diffusion errors diffused in accompaniment with quantization of the pixels X1 to X10. More specifically, the line accumulative errors BX11 to BX15 represent the sum of the diffusion errors that have been diffused to the pixels X11 to X15, respectively, on the basis of the third-line diffusion coefficients, when the line including the pixels X1 to X5 acts as the first line. On the other hand, the line accumulative errors BX16 to BX20 represent the sum of the diffusion errors that have been diffused to the pixels X16 to X20, respectively, on the basis of the third-line diffusion coefficients, when the line including the pixels X6 to X10 acts as the first line.

In the tone reproduction processing section 19C shown in FIG. 9, at that point in time when the pixels X1 to X5 have been quantized, the line accumulative errors BX11 to BX15 are stored in the line error storage portion 693e. Subsequently, the changing of the first line takes place so that the line including the pixels X6 to X10 may become the first line, and the pixels X6 to X10 are quantized. During this period of time, the line accumulative errors BX11 to BX15 are kept stored.

For example, the line accumulative error BX11 is kept stored between the instant when the quantization error in the pixel X1 is diffused and the instant when quantization of the pixel X11 is started, that is; during the time while all of the pixels belonging to two lines are quantized. Thus, in the line error storage portion 693e, the line accumulative errors BX16 to BX20, derived on the basis of the quantization errors in the pixels X6 to X10 respectively, and the line accumulative errors BX11 to BX15 need to be stored separately in different storage regions. FIG. 12E indicates the storage status of the line accumulative errors in the line error storage portion 693e, as observed upon the pixels X1 to X10 being quantized.

In the tone reproduction processing section 19D shown in FIG. 11, at that point in time when all of the pixels X1 to X5 have been quantized, the line accumulative errors BX11 to BX15 are stored in the line error storage portion 693f.

After the line including the pixels X6 to X10 became the first line and the quantization errors in the pixels X6, and X7 have been diffused one after another, the line accumulative error BX11 read out from the line error storage portion 693f is added, by the adder 692f, to the division result produced by the divider 692c corresponding to the pixel X11, now belonging to the second line. The addition result is then stored in the line error storage portion 692e as the line accumulative error AX11. At this time, instead of the line accumulative error BX11 read out, the accumulative error BX16 resulting from diffusion of the quantization error in the pixel X7 can be stored in that storage region of the line error storage portion 693f.

For example, assuming that the pixel value, the denominator component of the diffusion coefficient, and the numerator component thereof are each 8 bits, then the output from each of the dividers is 10 bits. In the adder 692f of the second line accumulative error calculation portion 692, the division result produced by the divider 692c and the output from the third line accumulative error calculation portion 693 are added to each other. This requires the line error storage portion 692e to hold 11-bit line accumulative errors 1 bit larger than the division result. However, the storage capacity of the line error storage portion 693f can be half the storage capacity of the line error storage portion 693e; wherefore the overall storage capacity can be reduced greatly.

FIG. 13 is a flow chart for explaining a method of image processing effected by the tone reproduction processing section 19D shown in FIG. 11. This image processing method is accomplished by executing a program stored in the memory under the control of the CPU incorporated in the color image processing apparatus 10, for instance. The image processing operation is started in accompaniment with an error diffusion process in the tone reproduction processing required for generating output image data.

In Step U1, an accumulative error is added to a pixel value representing the pixel density of input image data. In Step U2, the pixel value added with the accumulative error is quantized to obtain a quantization value for a pixel constituting output image data. In Step U3, the difference between the pixel value added with the accumulative error and the quantization value obtained by quantizing the pixel value is calculated as a quantization error.

In Step U4, the quantization error and the value of each numerator component of the diffusion coefficient are multiplied with each other. This multiplication operation is performed sequentially for each line to which the quantization error in a given pixel of a single line is distributed, that is; error-diffusion line by error-diffusion line. The multiplication result is then added to the addition result on the corresponding pixel stored in the computation result storage portion consisting of a memory. Each of the addition results is stored in the computation result storage portion as a new addition result. With respect to a pixel for which no addition result is stored, a numeral “0” is added to the multiplication result, and the resultant addition result is stored in the computation result storage portion. Alternatively, in a case where the computation result storage portion has a room in its storage capacity, a numeral “0” may be stored as an initial value pixel position by pixel position, or the multiplication result may be stored as it is without performing any addition operation.

In Step U5, the addition result, namely, the sum total of the multiplication results, is divided by the value of the denominator component of the diffusion coefficient on a line-by-line basis, that is; error-diffusion line by error-diffusion line. The division result is taken as a line accumulative error. In Step U6, with respect to the pixel of a line to which attention is drawn (which is called “attentional line” hereinafter), the line accumulative error for a single given pixel and, among the line accumulative errors corresponding to a line one line behind of the attentional line, namely, the next line, a line accumulative error corresponding to the pixel are added to each other. The addition result is taken as a new line accumulative error for the pixel included in the attentional line.

In Step U7, with respect to a pixel to be quantized next, all of the line accumulative errors are summed to generate an accumulative error. In Step U8, a check is made for whether all of the pixels constituting input image data have undergone error diffusion processing or not. If it is found that all of the pixels have been processed, the procedure will come to an end. If not, the procedure will return to Step U1 where an unprocessed pixel is subjected to error diffusion processing.

In any of the embodiments thus far described, the divider, specifically, the divider 681c, the divider 682c, the divider 691c, the divider 692c, and the divider 693c may be designed to perform division operations under the condition that a quantization error is expressed by a binary number, and the denominator component of the diffusion coefficient is expressed by 2 raised to the n-th power, where n represents an integer.

In a division operation using the denominator component of the diffusion coefficient that is expressed by the n-th power of 2, by excluding low-order n bits from a binary number to be divided, it is possible to determine a value consisting of remaining bits of the binary number as a quotient. Such a division operation can be realized by a binary shift operation. In this case, the remainder number is dropped, In order to round off, when the most significant bit of the discarded bit is “1”, a numeral “1” is added to the least significant bit of the quotient.

The error diffusion method is not limited to binary error diffusion, but may be of multi-value error diffusion such as 4-value or 16-value error diffusion. Otherwise, a plurality of groups of the numerator component of a diffusion coefficient may be prepared for use. In this case, the numerator components are selectable depending upon a random number in use or a region discrimination result.

In this way, the line accumulative error corresponding to the next error diffusion line and the division result produced in the above-described division process for the pixel corresponding to the line accumulative error are added to each other. It is thus essential only that the memory for storing therein the line accumulative error corresponding to the third error diffusion line be given enough capacity for as many line accumulative errors as the number of pixels belonging to a single line. Thus, in contrast to the case where the division result and the line accumulative error corresponding to the next error diffusion line are not added to each other, the larger the number of error diffusion lines to which the quantization error is distributed, the smaller the memory capacity of the line error storage portion can be.

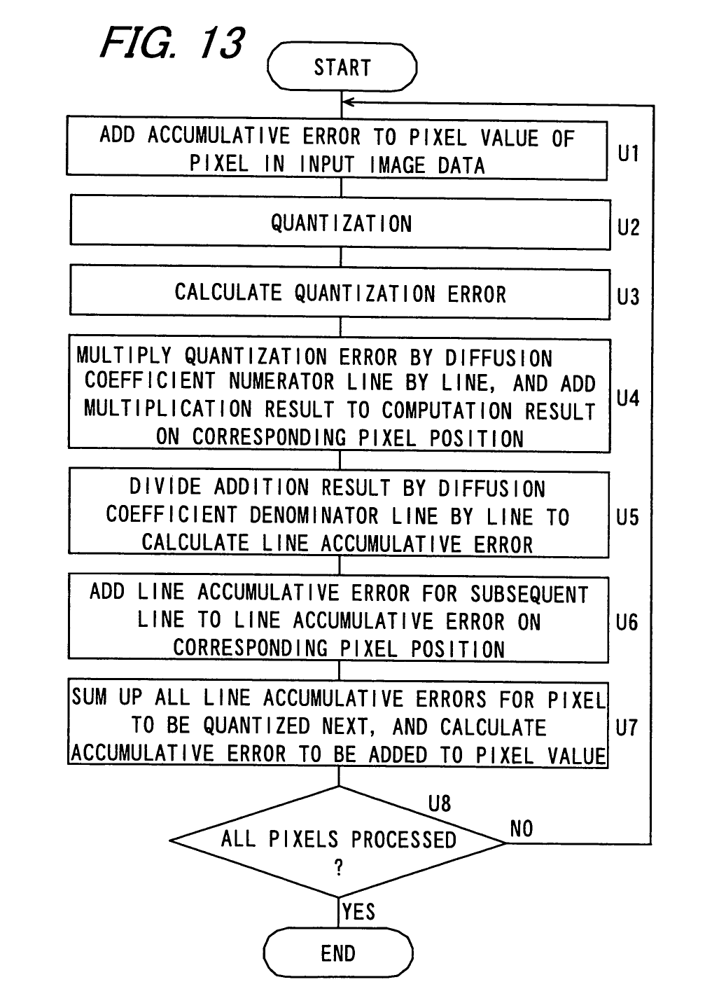

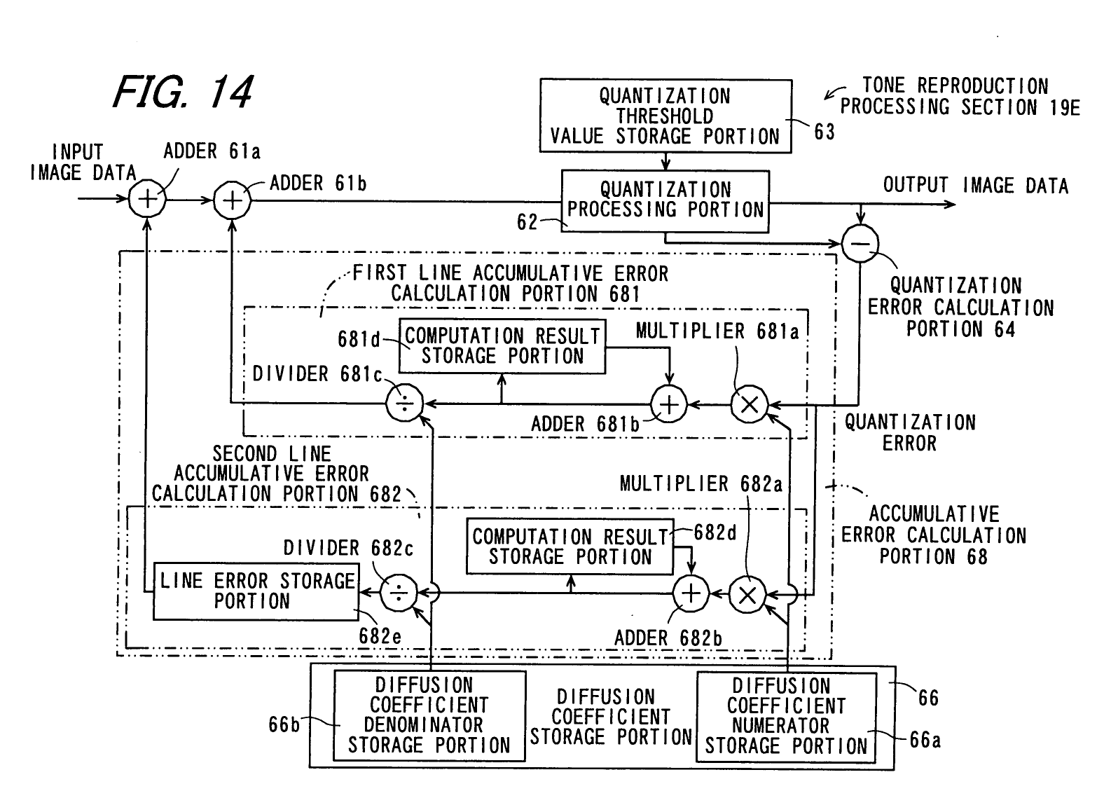

FIG. 14 is a block diagram showing a tone reproduction processing section 19E of a sixth example included in the image processing apparatus 10 according to yet another embodiment of the invention. This tone reproduction processing section 19E is composed of an adder 61a, an adder 61b, a quantization processing portion 62, a quantization threshold value storage portion 63, a quantization error calculation portion 64, a diffusion coefficient storage portion 66, and an accumulative error calculation portion 68. As compared with the tone reproduction processing section 19B shown in FIG. 6, in the sixth example, the adder 683 is left out, and, instead of the adder 61, two pieces of adders 61a and 61b are disposed.

In the adder 61a, with respect to a pixel to be quantized next, a pixel value representing the pixel density of input image data and the line accumulative error outputted from the second line accumulative error calculation portion 682 are added to each other. In the adder 61b, with respect to the pixel to be quantized next, the addition result produced by the adder 61a and the line accumulative error outputted from the first line accumulative error calculation portion 681 are added to each other. Note that no explanation will be given as to the other components that play the same or corresponding roles as in the tone reproduction processing section 19B shown in FIG. 6.

The second line accumulative error calculation portion 682 generates a line accumulative error resulting from diffusion of the quantization error in a pixel belonging to a line one line ahead of a line including a pixel to be quantized next. Thus, the line accumulative error has already been stored in the line error storage portion 682e before the pixel to which the line accumulative error is added is quantized. That is, all that needs to be done by the second line accumulative error calculation portion 682 is to read out a line accumulative error to be added to a pixel to be quantized next from the line error storage portion 682e. The output of the line accumulative error can accordingly be produced in short order.

The first line accumulative error calculation portion 681 generates a line accumulative error for a pixel to be quantized next on the basis of the quantization error in a quantized pixel. Therefore, there is a delay of time by a necessary calculation time before the line accumulative error is outputted. For example, the adders 61a and 61b are defined as the first addition means.

In this way, during the time while line accumulative errors are being calculated by the first line accumulative error calculation portion 681, in the adder 61a, the line accumulative error produced by the second line accumulative error calculation portion 682 is added to the pixel value of a pixel constituting input image data. Thus, as compared with the tone reproduction processing section 19 shown in FIG. 6, quantization of the next pixel can be started more quickly in the absence of the time spent in an addition operation effected by the adder 683.

Also in the tone reproduction processing section 19C and 19D shown in FIGS. 9 and 11, two pieces of adders 61a and 61b may be disposed instead of the adder 61. In this case, the tone reproduction processing section 19C shown in FIG. 9 is so designed that the addition result produced by the adder 695 is inputted to the adder 61a.

The image processing method as illustrated in FIGS. 8 and 13 may be provided in the form of a software program which is executed by the computer 50 as shown in FIG. 5. Moreover, the program may be incorporated in and executed by the computer 50 as the tone reproduction processing section 513 included in the printer driver 51. Further, the program may be recorded on such a recording medium as described earlier.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

1. An image processing apparatus comprising;
first addition means for adding, an accumulative error distributed to a pixel to be quantized to a pixel value of the pixel to be quantized, among accumulative errors resulting from distribution of a quantization error attendant upon quantization of a pixel value representing a pixel density of an input image to other pixels;
quantization processing means for generating a quantization value for a pixel constituting an output image by quantizing the pixel value added with the accumulative error by the first addition means;
quantization error calculation means for calculating a difference between the pixel value added with the accumulative error by the first addition means and the quantization value generated in the quantization processing means as a quantization error;
multiplication means for multiplying the quantization error generated by calculation in the quantization error calculation means by a value of each of numerators of a diffusion coefficient represented by a fraction indicating a proportion of the quantization error to be distributed to other pixels;
second addition means for adding, a multiplication result corresponding to a pixel to be quantized next, among multiplication results produced by the multiplication means; and
division means for dividing an addition result produced by the second addition means by a value of a denominator of the diffusion coefficient represented by the fraction,
wherein a division result produced by the division means is taken as an accumulative error which is distributed to a pixel to be quantized next.

2. The image processing apparatus of claim 1, further comprising:
error storage means for storing therein the quantization error generated by calculation in the quantization error calculation means,
wherein the multiplication means serves to multiply, among the quantization errors stored in the error storage means, a quantization error to be distributed to a pixel to be quantized next, by the value of the numerator of the diffusion coefficient that corresponds to the quantization error to be distributed, and
wherein the second addition means serves to add computation results produced by the multiplication means.

3. An image processing apparatus comprising:
first addition means for adding, with respect to an input image composed of plural lines each including plural pixels, an accumulative error distributed to a pixel to be quantized to a pixel value of the pixel to be quantized, among accumulative errors resulting from distribution of a quantization error attendant upon quantization of a pixel value representing a pixel density of the input image to other pixels;
quantization processing means for generating a quantization value for a pixel constituting an output image by quantizing the pixel value added with the accumulative error by the first addition means;
quantization error calculation means for calculating a difference between the pixel value added with the accumulative error by the first addition means and the quantization value generated in the quantization processing means as a quantization error;
multiplication means for multiplying the quantization error generated by calculation in the quantization error calculation means by a value of each of numerators of a diffusion coefficient represented by the fraction indicating a proportion of the quantization error to be distributed to other pixels;
line accumulative error calculation means including:
second addition means for adding, with respect to plural error diffusion lines including pixels to which a quantization error in a pixel included in a quantization line including pixels to be quantized is distributed, a multiplication result produced by the multiplication means on the basis of the quantization error in the pixel included in the quantization line, on a pixel-by-pixel basis, and
division means for dividing an addition result produced by the second addition means by a value of a denominator of the diffusion coefficient represented by the fraction,
the line accumulative error calculation means calculating a division result produced by the division means as a line accumulative error, the line accumulative error calculation means being provided for each of the error diffusion lines; and
third addition means for adding, with respect to a pixel to be quantized next, line accumulative errors generated by calculation in the line accumulative error calculation means corresponding to the individual error diffusion lines,
wherein an addition result produced by the third addition means is taken as an accumulative error which is distributed to the pixel to be quantized next.

4. The image processing apparatus of claim 3, wherein the line accumulative error calculation means for the last error diffusion line including a pixel to be quantized last includes first line error storage means for storing therein a division result produced by the division means, and calculates the division result stored in the first line error storage means as a line accumulative error,
wherein another line accumulative error calculation means for each of the error diffusion lines other than the last error diffusion line and the first error diffusion line including a pixel to be quantized first includes fourth addition means for adding a division result produced by the division means to a line accumulative error generated with respect to a pixel corresponding to the division result by calculation in yet another accumulative error calculation means corresponding to the error diffusion line subsequent to the error diffusion line of interest, and second line error storage means for storing therein an addition result produced by the fourth addition means, and calculates the addition result stored in the second line error storage means as a line accumulative error, and
wherein the third addition means serves to add up, instead of line accumulative errors generated by calculation by the accumulative error calculation means, line accumulative errors generated by calculation by other line accumulative error calculation means for the first error diffusion line and the next line accumulative error calculation means for the error diffusion line subsequent to the first error diffusion line.

5. An image forming apparatus comprising:
the image processing apparatus of claim 1; and
an image output device for producing an output image that has been undergone a quantization process in the image processing apparatus.

6. An image forming apparatus comprising:
the image processing apparatus of claim 3; and
an image output device for producing an output image that has been undergone a quantization process in the image processing apparatus.

7. An image processing method comprising:
a first addition step of adding, an accumulative error distributed to a pixel to be quantized to a pixel value of the pixel to be quantized, among accumulative errors resulting from distribution of a quantization error attendant upon quantization of a pixel value representing a pixel density of an input image to other pixels;
a quantization step of generating a quantization value for a pixel constituting an output image by quantizing the pixel value added with the accumulative error in the first addition step;
a quantization error calculation step of calculating a difference between the pixel value added with the accumulative error in the first addition step and the quantization value generated in the quantization step as a quantization error;
a multiplication step of multiplying the quantization error generated by calculation in the quantization error calculation step by a value of each of numerators of a diffusion coefficient represented by a fraction indicating a proportion of the quantization error to be distributed to other pixels;
a second addition step of adding, a multiplication result corresponding to a pixel to be quantized next, among multiplication results produced in the multiplication step; and
a division step of dividing an addition result produced in the second addition step by a value of a denominator of the diffusion coefficient represented by the fraction,
wherein a division result produced in the division step is taken as an accumulative error which is distributed to the pixel to be quantized next.

8. An image processing method comprising:
a first addition step of adding, with respect to an input image composed of plural lines each including plural pixels, an accumulative error distributed to a pixel to be quantized to a pixel value of the pixel to be quantized, among accumulative errors resulting from distribution of a quantization error attendant upon quantization of a pixel value representing a pixel density of the input image to other pixels;
a quantization step of generating a quantization value for a pixel constituting an output image by quantizing the pixel value added with the accumulative error in the first addition step;
a quantization error calculation step of calculating a difference between the pixel value added with the accumulative error in the first addition step and the quantization value generated in the quantization step as a quantization error;
a multiplication step of multiplying the quantization error generated by calculation in the quantization error calculation step by a value of each of numerators of a diffusion coefficient represented by a fraction indicating a proportion of the quantization error to be distributed to other pixels;
a second addition step of adding, with respect to plural error diffusion lines including pixels to which a quantization error in a pixel included in a quantization line including pixels to be quantized is distributed, a multiplication result produced in the multiplication step on the basis of the quantization error in the pixel included in the quantization line, on a pixel-by-pixel basis;
a division step of dividing an addition result produced in the second addition step by a value of a denominator of the diffusion coefficient represented by the fraction;
a line accumulative error calculation step of calculating a division result produced in the division step as a line accumulative error, error-diffusion line by error-diffusion line; and
a third addition step of adding, with respect to a pixel to be quantized next, line accumulative errors generated by calculation error-diffusion line by error-diffusion line in the line accumulative error calculation step,
wherein an addition result produced in the third addition step is taken as an accumulative error which is distributed to the pixel to be quantized next.

9. The image processing method of claim 8, wherein in the line accumulative error calculation step, with respect to each of the error diffusion lines other than the first error diffusion line including a pixel to be quantized first and the last error diffusion line including a pixel to be quantized last, a division result produced in the division step and, a line accumulative error generated for a pixel corresponding to the division result, among line accumulative errors generated for the error diffusion line subsequent to the error diffusion line of interest corresponding to the division result, are added to each other, for generating a line accumulative error, and
wherein in the third addition step, instead of the line accumulative errors generated for the individual error diffusion lines, line accumulative errors corresponding to the first error diffusion line and the error diffusion line subsequent to the first error diffusion line are added together.

10. A program for causing a computer to function as the image processing apparatus of claim 1.

11. A program for causing a computer to function as the image processing apparatus of claim 3.

12. A computer-readable recording medium for recording therein the program of claim 10.

13. A computer-readable recording medium for recording therein the program of claim 11.
